(19) United States
(12) Patent Application Publication
(10) Pub. No.: US 2026/0261965 A1
(43) Pub. Date: Sep. 3, 2026

(54) COMMUNICATION CONTROL DEVICE, COMMUNICATION CONTROL METHOD, AND PROGRAM

(71) Applicant: SONY GROUP CORPORATION, Tokyo (JP)

(72) Inventor: Kosuke AIO, Tokyo (JP)

(21) Appl. No.: 18/869,514

(22) PCT Filed: May 17, 2023
(86) PCT No.: PCT/JP2023/018382

§ 371 Date: Nov. 26, 2024

(30) Foreign Application Priority Data
Jun. 3, 2022 (JP) 2022-091065

(51) Int. Cl. H04W 48/20; H04W 4/38

(52) U.S. Cl. CPC H04W 48/20; H04W 4/38

(57) ABSTRACT

The present technology relates to a communication control device, a communication control method, and a program that enable appropriate communication of a backscatter signal. A communication control device determines a communication device that plays a first role of transmitting a third wireless signal necessary for a backscatter signal generation device to generate a third backscatter signal on the basis of first reception quality information relating to reception quality of a first backscatter signal generated by the backscatter signal generation device on the basis of a first wireless signal and second reception quality information relating to reception quality of a second backscatter signal generated by the backscatter signal generation device on the basis of a second wireless signal. The present technology can be applied to a wireless communication system.

### TECHNICAL FIELD

The present technology relates to a communication control device, a communication control method, and a program, and more particularly to a communication control device, a communication control method, and a program that enable appropriate communication of a backscatter signal.

### BACKGROUND ART

In recent years, in a situation where sensor tags for Internet of Things (IoT) communication are rapidly increasing, Sustainable IoT (Passive IoT) that does not require battery replacement of sensor tags has attracted attention.

There is a plurality of embodiments of the Sustainable IoT, and implementation of a Backscatter Communication System (hereinafter, BCS), which is one of the plurality of embodiments, has been studied. The BCS is a technique in which a sensor tag on a transmission side captures a carrier wave (hereinafter also referred to as scattered wave) scattered around and reflects and/or absorbs the carrier wave using a method of modulating the carrier wave while controlling reception impedance, thereby transmitting information to a reception side (Reader). According to the BCS, since generation of a carrier wave is not required on the transmission side and an amplifier is not necessary, it is possible to transmit information with small power consumption of several tens of μW.

The BCS has been mainly used in Passive RFIDs so far. In recent years, an Ambient Backscatter Communication System (hereinafter, ABCS) that reflects various RF signals has been widely studied. In the ABCS, by using an RF signal actually transmitted around instead of a dedicated signal wave, it is not necessary to use a dedicated device for power supply, and it is expected to reduce installation cost. A wireless LAN signal in a 2.4 GHz band is easy to use because a wide band is available and is most widely used among the surrounding RF signals. Therefore, in the ABCS, the wireless LAN signal of the 2.4 GHz band is listed as a candidate for the RF signal to be used.

Non-Patent Document 1 describes an embodiment of an ABCS using a wireless local area network (LAN) protocol. Specifically, Non-Patent Document 1 describes a method of transmitting Backscatter DATA (hereinafter, BCS DATA or backscatter signal) that is a wireless signal to an Access Point (hereinafter AP) by performing reflection and/or absorption using a method in which a sensor tag (hereinafter, tag) applies modulation to a data signal to be transmitted from the AP to a Station (hereinafter STA).

In this case, since the AP simultaneously performs transmission and reception at the same frequency, it is necessary to support In-band Full Duplex (hereinafter, in-band FD), for example. Hereinafter, a role of transmitting the RF signal to reflect and/or absorb for the Tag to generate the BCS DATA will be called Power Supplier (PS) and a role of receiving the BCS DATA will be called Reader.

Furthermore, Patent Document 1 discloses a radio wave condition training method applicable to the Backscatter Communication System.

### CITATION LIST

### Non Patent Document

Non-Patent Document 1: A. Iqbal and T.-J. Lee, “Communication MAC Protocol for Coexisting Wireless Devices and Backscatter Tags”, [online], 2020 14th International Conference on Ubiquitous Information Management and Communication (IMCOM), 2020, pp. 1-6, doi: 10.1109/IMCOM48794.2020.9001693, [searched on April 6, 2022], Internet <URL: https://ieeexplore.ieee.org/document/9001693>

### PATENT DOCUMENT

### Patent Document 1: WO 2021/240699 A

### SUMMARY OF THE INVENTION

### Problems to be Solved by the Invention

As a method of performing ABCS communication even if the above-described special function is not provided in the AP, a method of using an environment in which a plurality of APs exists is conceivable. For example, in an office environment or a factory environment, there are many environments in which a plurality of APs is set in one room, and in recent years, an environment in which a plurality of APs is in one home has also increased due to the spread of Home Mesh AP products.

Therefore, in order for the STA to receive (acquire) the BCS DATA, there is an urgent need for a mechanism for determining, from among the plurality of APs, a communication device that plays the role related to communication of a backscatter signal, such as the Power Supplier or the Reader, and executing the role.

Note that the training method described in Patent Document 1 is merely a method of determining beam control that maximizes reception power on the Reader side that receives the BCS DATA, and is not a method of determining the roles such as the Power Supplier and the Reader.

The present technology has been made in view of such a situation, and an object thereof is to enable appropriate communication of a backscatter signal.

### Solutions to Problems

A communication control device according to one aspect of the present technology includes a communication control unit configured to determine a communication device that plays a first role of transmitting a third wireless signal necessary for a backscatter signal generation device to generate a third backscatter signal on the basis of first reception quality information relating to reception quality of a first backscatter signal generated by the backscatter signal generation device on the basis of a first wireless signal and second reception quality information relating to reception quality of a second backscatter signal generated by the backscatter signal generation device on the basis of a second wireless signal.

In one aspect of the present technology, a communication device that plays a first role of transmitting a third wireless signal necessary for a backscatter signal generation device to generate a third backscatter signal is determined on the basis of first reception quality information relating to reception quality of a first backscatter signal generated by the backscatter signal generation device on the basis of a first wireless signal and second reception quality information relating to reception quality of a second backscatter signal generated by the backscatter signal generation device on the basis of a second wireless signal.

### BRIEF DESCRIPTION OF DRAWINGS

FIG. 1 is a diagram illustrating a configuration example of a wireless communication system according to an embodiment of the present technology.

FIG. 2 is a block diagram illustrating a configuration example of a communication device that operates as an AP.

FIG. 3 is a block diagram illustrating a configuration example of a communication device that operates as an STA.

FIG. 4 is a block diagram illustrating a configuration example of a communication device that operates as a Tag.

FIG. 5 is a diagram illustrating an overall sequence according to the embodiment of the present technology.

FIG. 6 is a diagram illustrating a configuration example of an ABCS Operating Mode Notification frame.

FIG. 7 is a diagram illustrating a first sequence in Training Phase.

FIG. 8 is a diagram illustrating a second sequence in the Training Phase.

FIG. 9 is a diagram illustrating a configuration example of the Coordination Request frame.

FIG. 10 is a diagram illustrating a configuration example of the Coordination Response frame.

FIG. 11 is a diagram illustrating a configuration example of a TRN Request frame.

FIG. 12 is a diagram illustrating a configuration example of a TRN Response frame.

FIG. 13 is a diagram illustrating a configuration example of TSP.

FIG. 14 is a diagram illustrating a configuration example of an ABCS Setup frame.

FIG. 15 is a flowchart for describing processing of the AP in the Training Phase.

FIG. 16 is a diagram illustrating a first sequence of ABCS Phase.

FIG. 17 is a diagram illustrating a second sequence of the ABCS Phase.

FIG. 18 is a diagram illustrating the third sequence of the ABCS Phase.

FIG. 19 is a diagram illustrating a fourth sequence of the ABCS Phase.

FIG. 20 is a diagram illustrating a configuration example of an ABCS Request frame.

FIG. 21 is a diagram illustrating a configuration example of an ABCS Response frame.

FIG. 22 is a flowchart for describing processing of the AP when the AP acquires transmission right.

FIG. 23 is a block diagram illustrating another configuration example of a communication device that operates as an AP.

FIG. 24 is a block diagram illustrating another configuration example of a communication device that operates as an STA.

FIG. 25 is a block diagram illustrating a configuration example of a computer.

FIG. 26 is a block diagram illustrating a schematic configuration example of a smartphone to which the present technology is applied.

FIG. 27 is a block diagram illustrating a schematic configuration example of an in-vehicle device to which the present technology is applied.

FIG. 28 is a block diagram illustrating a schematic configuration example of a wireless AP to which the present technology is applied.

### MODE FOR CARRYING OUT THE INVENTION

Hereinafter, modes for carrying out the present technology will be described. The description will be given in the following order.

1. Embodiments

2. Modifications

3. Application Example

4. Other

### <1. Embodiment>

<System Configuration>

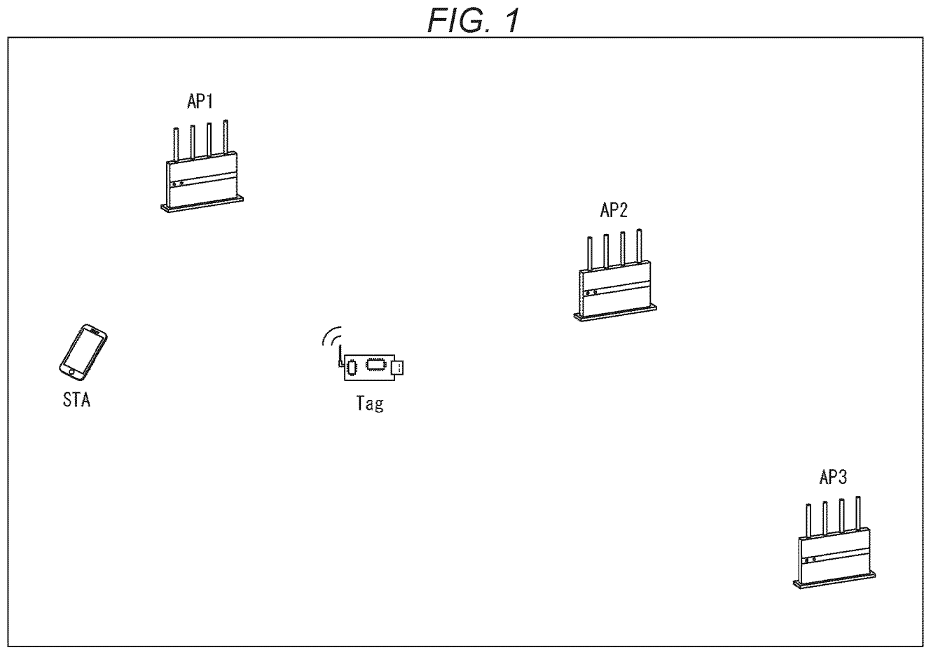

FIG. 1 is a diagram illustrating a configuration example of a wireless communication system according to an embodiment of the present technology.

The wireless communication system of FIG. 1 is a system that performs ABCS communication for acquiring BCS DATA to which information such as sensor data from a Tag is added, using a surrounding scattered wave instead of a dedicated signal wave.

In FIG. 1, the wireless communication system includes an AP1 to an AP3 that are three APs, an STA that is one STA, and one sensor tag, Tag. Note that the AP1 to the AP3 will be referred to as AP(s) in a case where it is not particularly necessary to distinguish them.

At least one of the AP1 to AP3 transmits a signal to the STA, the AP other than itself, or the like.

The STA is connected to the AP1. The STA directly receives the BCS DATA transmitted from the Tag. Note that there is a case where any AP once receives the BCS DATA transmitted from the Tag and then transmits (transfers) the BCS DATA to the STA, whereby the STA indirectly receives the BCS DATA, depending on the communication quality status to be described below.

The Tag transmits the BCS DATA (backscatter signal), which is a wireless signal, to the STA or the AP, using a method of modulating, reflecting and/or absorbing a signal transmitted from a surrounding AP or STA.

Note that the target system configuration in the present technology is not limited thereto. That is, in the target system configuration, it is sufficient if a plurality of communication devices to which connection is established exists, and other communication devices exist around each of the communication devices. Furthermore, as long as the conditions described above in FIG. 1 are satisfied, the positional relationship among the communication devices is not limited.

Moreover, in the present embodiment, description will be given by distinguishing the AP and the STA from each other in terms of devices, but the AP may have a configuration to operate as an AP even if the operation is limited while taking the device configuration of the STA, for example. For example, an AP may function as an STA in the wireless communication system of FIG. 1, and the wireless communication system may be configured as a system that performs ABCS communication using ad-hoc communication (P2P communication) between STAs.

### <Configuration of Communication Device>

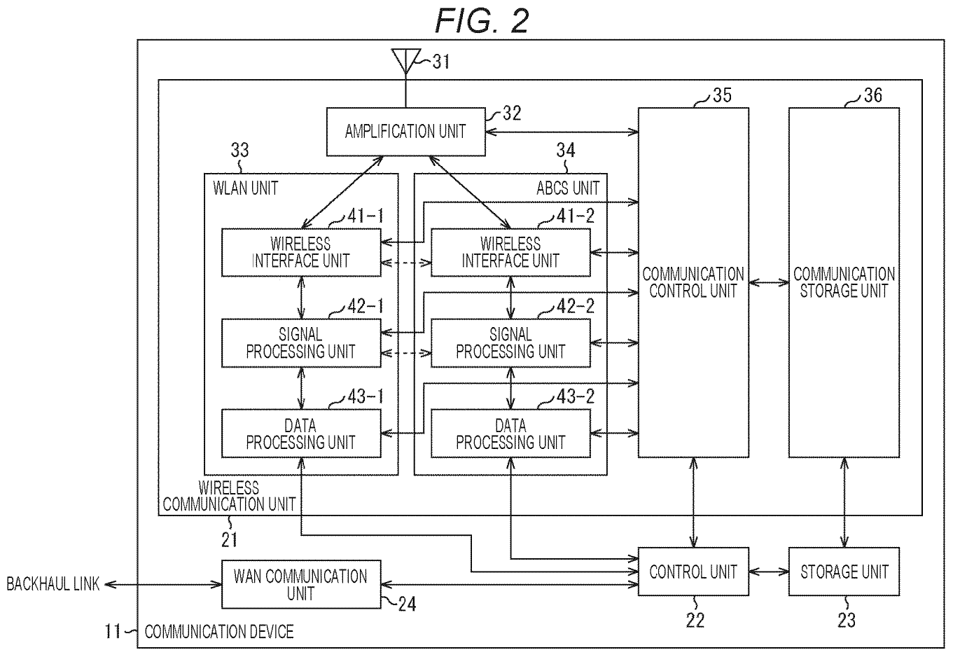

FIG. 2 is a block diagram illustrating a configuration example of a communication device that operates as the AP.

A communication device 11 includes a wireless communication unit 21, a control unit 22, a storage unit 23, and a wide area network (WAN) communication unit 24.

The wireless communication unit 21 transmits and receives data.

The wireless communication unit 21 includes an antenna 31, an amplification unit 32, a WLAN unit 33 that is a block for wireless LAN communication, an ABCS unit 34 that is a block for ABCS communication, a communication control unit 35, and a communication storage unit 36. That is, in the wireless communication unit 21, the antenna 31 and the amplification unit 32 are shared by the WLAN unit 33 and the ABCS unit 34.

The WLAN unit 33 includes a wireless interface unit 41-1, a signal processing unit 42-1, and a data processing unit 43-1. The ABCS unit 34 includes a wireless interface unit 41-2, a signal processing unit 42-2, and a data processing unit 43-2.

Note that, in a case where it is not necessary to distinguish the wireless interface units 41-1 and 41-2, they are referred to as wireless interface unit(s) 41. In a case where it is not necessary to distinguish the signal processing units 42-1 and 42-2, they are referred to as signal processing unit(s) 42. In a case where it is not necessary to distinguish the data processing units 43-1 and 43-2, they are referred to as data processing unit(s) 43.

Hereinafter, processing content in each block will be described assuming a wireless LAN, but the ABCS unit 34 does not need to support the entire processing content and may perform only some part of the processing content. Furthermore, the ABCS unit 34 may perform a unique operation according to a wireless standard used for transmission of the BCS DATA.

Note that the AP may include a larger number of the antennas 31 and the amplification units 32 to enable high-dimensional multi-input multi-output (MIMO) transmission/reception processing. Furthermore, the AP may include a plurality of the wireless interface units 41, a plurality of the signal processing units 42, and a plurality of the data processing units 43 so as to operate a plurality of links or a plurality of frequency channels in parallel.

At the time of transmission, the amplification unit 32 amplifies power of an analog signal supplied from the wireless interface unit 41 to predetermined power, and outputs the analog signal with the amplified power to the antenna 31. At the time of reception, the amplification unit 32 amplifies power of an analog signal supplied from the antenna 31 to predetermined power, and outputs the analog signal with the amplified power to the wireless interface unit 41.

A part of the function of the amplification unit 32 may be included in the wireless interface unit 41. Furthermore, a part of the function of the amplification unit 32 may be a component outside the wireless communication unit 21.

At the time of transmission, the wireless interface unit 41 converts a transmission symbol stream from the signal processing unit 42 into an analog signal, and performs filtering, up-conversion to a carrier frequency, and phase control. The wireless interface unit 41 outputs the analog signal after the phase control to the amplification unit 32.

At the time of reception, the wireless interface unit 41 performs phase control, down-conversion, and reverse filtering for the analog signal supplied from the amplification unit 32, and outputs a reception symbol stream obtained as a result of conversion into a digital signal to the signal processing unit 42.

Here, as indicated by the dashed arrows in FIG. 2, the wireless interface units 41 and the signal processing units 42 of the WLAN unit 33 and the ABCS unit 34 may be designed to exchange information with each other. In this case, the connection between the wireless interface units 41 is used for information exchange for causing an analog interference canceller to function. Furthermore, the connection between the signal processing units 42 is used for information exchange for causing a digital interference canceller to function. In a case where In-band FD or Non-orthogonal Multiple Access (NOMA) is performed in the communication device 11, at least one interference canceller is used.

At the time of transmission, the signal processing unit 42 performs encoding, interleaving, modulation, and the like for a data unit supplied from the data processing unit 43, adds a physical header, and generates a transmission symbol stream. The signal processing unit 42 outputs the generated transmission symbol stream to each wireless interface unit 41.

At the time of reception, the signal processing unit 42 analyzes the physical header of the reception symbol stream supplied from each wireless interface unit 41, performs demodulation, deinterleaving, decoding, and the like for the reception symbol stream, and generates a data unit. The signal processing unit 42 outputs the generated data unit to the data processing unit 43.

Note that the signal processing unit 42 performs complex channel characteristic estimation processing and spatial separation processing as necessary.

Furthermore, the signal processing unit 42 of the ABCS unit 34 generates a symbol stream of Tag Selection Pulse (hereinafter, TSP), which is a signal that permits the Tag to transmit the BCS DATA.

At the time of transmission, the data processing unit 43 performs sequence management and encryption processing of data held in the communication storage unit 36 and a control signal and management information received from the communication control unit 35. After the encryption processing, the data processing unit 43 adds a media access control (MAC) header and an error detection code to generate a packet. The data processing unit 43 performs concatenation processing of a plurality of the generated packets.

At the time of reception, the data processing unit 43 performs decoupling processing of the received packet, analysis of the MAC header, error detection, retransmission request operation, and reorder processing.

The communication control unit 35 controls operation of each unit of the wireless communication unit 21 and information transmission between the units. Furthermore, the communication control unit 35 performs control to transfer the control signal and the management information to be notified to another communication device to the data processing unit 43.

The communication storage unit 36 holds information to be used by the communication control unit 35. Furthermore, the communication storage unit 36 holds packets to be transmitted and received packets. A transmission buffer that holds the packets to be transmitted is included in the communication storage unit 36.

There may be a plurality of the wireless communication units 21. For example, the communication between the APs and the communication between the AP and the STA may be performed using different wireless communication units 21.

The control unit 22 includes a central processing unit (CPU), a read only memory (ROM), and a random access memory (RAM). The control unit 22 executes a program stored in the ROM or the like, and controls the wireless communication unit 21 and the communication control unit 35. Furthermore, the control unit 22 may also perform a part of the operation of the communication control unit 35 instead. Furthermore, the communication control unit 35 and the control unit 22 may be configured as one block.

The storage unit 23 holds information to be used by the wireless communication unit 21 and the control unit 22. Furthermore, the storage unit 23 may also perform a part of the operation of the communication storage unit 36 instead. The storage unit 23 and the communication storage unit 36 may be configured as one block.

The WAN communication unit 24 analyzes the packet acquired from a backhaul link that is a communication path with the AP, and passes the analyzed packet to the wireless communication unit 21 via the control unit 22. The format of the transferred packet may be a state in which an IP Header is left as it is (access point mode) or a state in which the IP Header is removed by the WAN communication unit 24 (router mode).

Note that FIG. 2 illustrates an example in which the wireless communication unit 21 is configured as one IC, but the IC configuration of the present technology is not limited thereto. For example, the wireless interface unit 41 may be mounted as an IC different from the IC of the wireless communication unit 21.

### <Configuration of Communication Device>

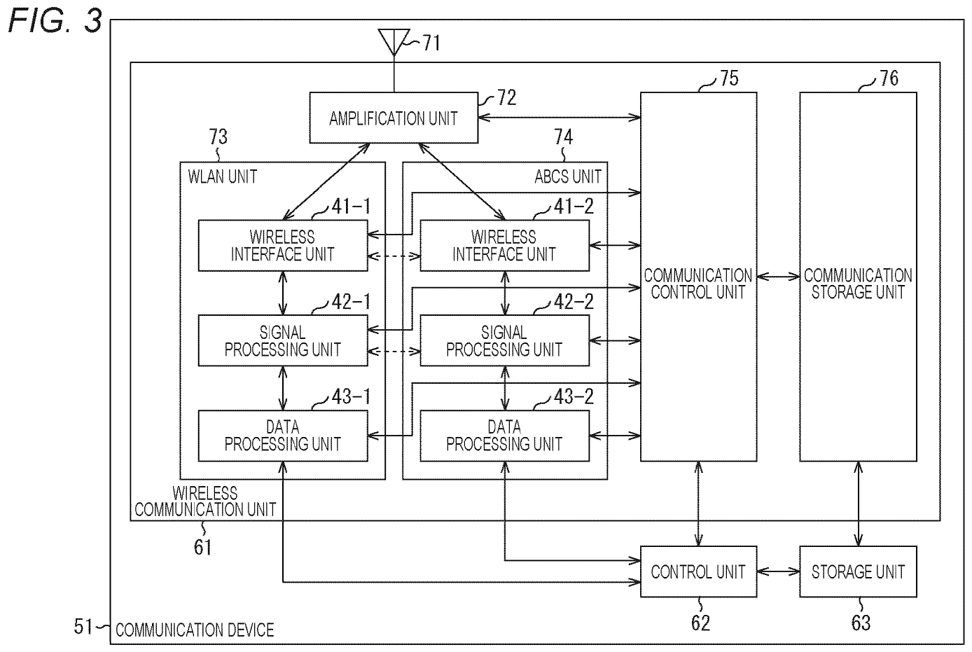

FIG. 3 is a block diagram illustrating a configuration example of a communication device that operates as the STA.

A communication device 51 includes a wireless communication unit 61, a control unit 62, and a storage unit 63.

The configurations of the control unit 62 and the storage unit 63 in FIG. 3 are similar to the configurations of the control unit 22 and the storage unit 23 in FIG. 2.

The wireless communication unit 61 includes an antenna 71, an amplification unit 72, a WLAN unit 73, an ABCS unit 74, a communication control unit 75, and a communication storage unit 76.

The configurations of the antenna 71, the amplification unit 72, the WLAN unit 73, the ABCS unit 74, the communication control unit 75, and the communication storage unit 76 in FIG. 3 are similar to the configurations of the antenna 31, the amplification unit 32, the WLAN unit 33, the ABCS unit 34, the communication control unit 35, and the communication storage unit 36 in FIG. 2.

### <Configuration of Communication Device>

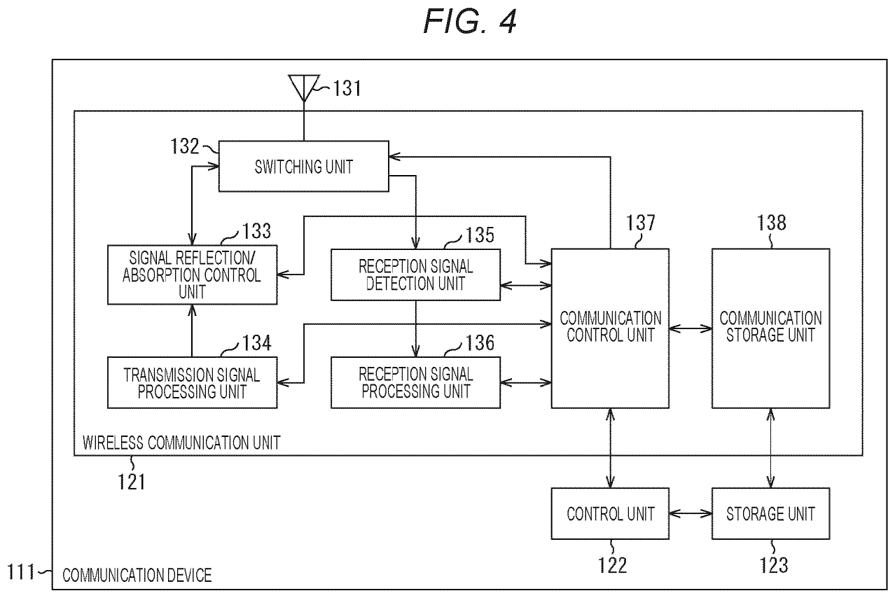

FIG. 4 is a block diagram illustrating a configuration example of a communication device that operates as the Tag.

A communication device 111 includes a wireless communication unit 121, a control unit 122, and a storage unit 123.

The configurations of the control unit 122 and the storage unit 123 in FIG. 4 are similar to the configurations of the control unit 22 and the storage unit 23 in FIG. 2.

The wireless communication unit 121 includes an antenna 131, a switching unit 132, a signal reflection/absorption control unit 133, a transmission signal processing unit 134, a reception signal detection unit 135, a reception signal processing unit 136, a communication control unit 137, and a communication storage unit 138. Note that the communication device 111 is different from the communication device 11 of FIG. 2 and the communication device 51 of FIG. 3 in that no amplification unit is present.

The switching unit 132 switches an input destination of a received wave received by the antenna 131. Specifically, after operating the reception signal detection unit 135 and acquiring a signal including its own identification information, the switching unit 132 switches the operation to the signal reflection/absorption control unit 133 to perform control to transmit the BCS DATA.

The signal reflection/absorption control unit 133 controls impedance of a reception circuit that reflects and/or absorbs an RF wave acquired from the antenna 131, and generates a transmission signal to which information of the symbol stream generated by the transmission signal processing unit 134 is added.

The transmission signal processing unit 134 performs encoding, interleaving, modulation, and the like for the data held in the communication storage unit 138 and control information and the management information received from the communication control unit 137. Then, the transmission signal processing unit 134 adds the physical header to the modulated data and information to generate the symbol stream. The transmission signal processing unit 134 outputs the generated symbol stream to the signal reflection/absorption control unit 133.

The reception signal detection unit 135 detects the TSP from the signal acquired by the switching unit 132, performs down-conversion, filtering, and analog-to-digital signal conversion to generate the symbol stream.

The reception signal processing unit 136 decodes the symbol stream generated by the reception signal detection unit 135 and acquires information.

The communication control unit 137 controls operation of each unit constituting the wireless communication unit 121 and information transmission between the units. Furthermore, the communication control unit 137 performs control to transfer the control information and the management information to be notified to another communication device to the reception signal processing unit 136.

The communication storage unit 138 holds information to be used by the communication control unit 137. Furthermore, the communication storage unit 138 holds a data packet to be transmitted and a received data packet. The communication storage unit 138 includes a transmission buffer that holds the data packets to be transmitted.

### <Overall Sequence>

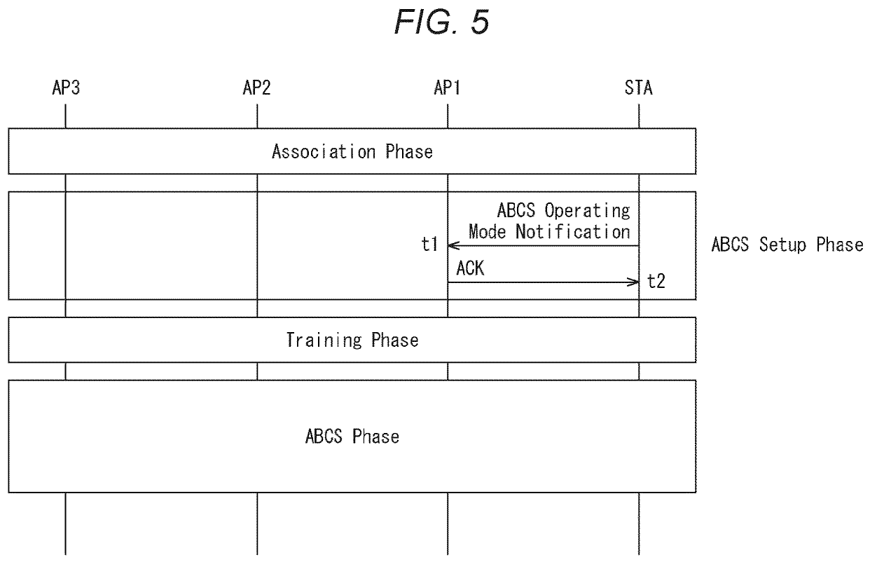

FIG. 5 is a diagram illustrating an overall sequence according to an embodiment of the present technology.

In FIG. 5, the overall sequence includes an Association Phase, an ABCS Setup Phase, a Training Phase, and an ABCS Phase. Note that, in FIG. 5, the processing by the AP1 to AP3, and STA will be mainly described, and thus the Tag is omitted for convenience of description.

In the Association Phase, the AP1 to AP3 and the STA perform connection processing and authentication processing between the APs and the STA. Furthermore, the AP1 to AP3 perform connection processing and authentication processing between the APs, and perform initial setting for performing coordinated operation and data signal transmission between the APs.

In the ABCS Setup Phase, the AP1 performs initial setting for collecting information from the Tag in response to a request transmitted from the STA.

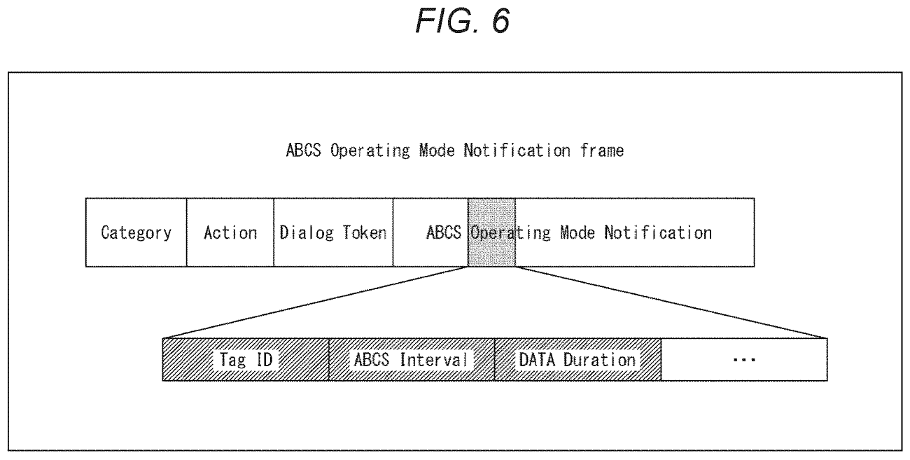

Specifically, at timing t1, the STA transmits an ABCS Operation Mode Notification frame, which is a request signal for obtaining information from the Tag (that is, for performing communication of ABCS), to the AP1. Details of the ABCS Operation Mode Notification frame will be described below with reference to FIG. 6.

The AP1 receives the ABCS Operation Mode Notification frame, and transmits an ACK frame, which is a reception confirmation response signal, to the STA at timing t2.

In the Training Phase, reception quality measurement at the time of receiving the BCS DATA for measurement (first backscatter signal or second backscatter signal) generated by the Tag on the basis of an RF signal (first wireless signal or second wireless signal) transmitted from surrounding communication devices is performed. The AP1 determines a communication device that plays a role related to communication of the BCS DATA from among the AP1 to AP3 and the STA on the basis of the measured reception quality. The role related to communication of the BCS DATA includes a Power Supplier (first role) that transmits an RF signal (third wireless signal) to be reflected and/or absorbed by the Tag to generate the BCS DATA and a Reader (second role) that receives the BCS DATA (third backscatter signal).

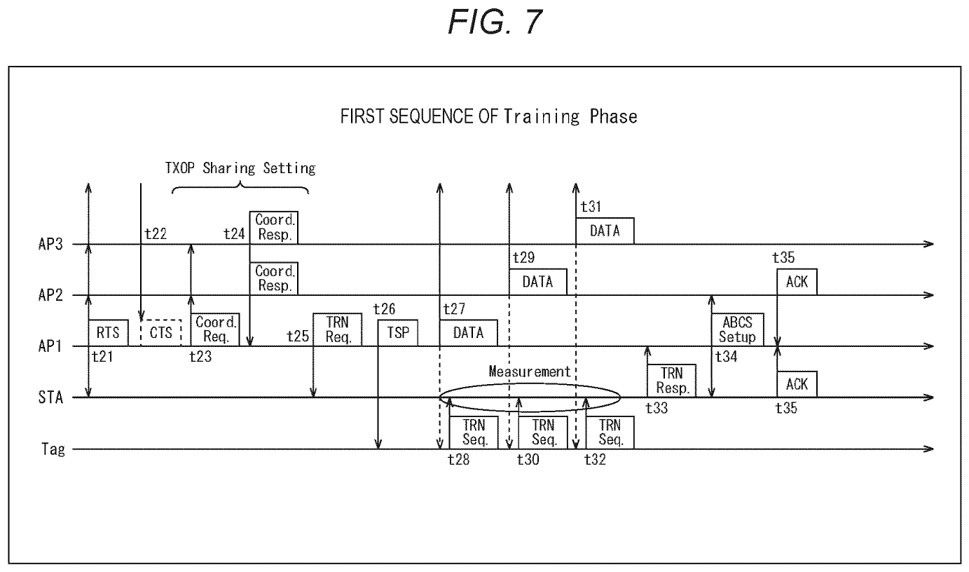

At that time, in the present technology, the reception quality of each of a plurality of Power Supplier candidates is measured for one Reader candidate. A detailed sequence of the Training Phase will be described below with reference to FIG. 7.

In the ABCS Phase, the Tag transmits the BCS DATA to the STA. At that time, ABCS communication is performed on the basis of the role determined in Training Phase.

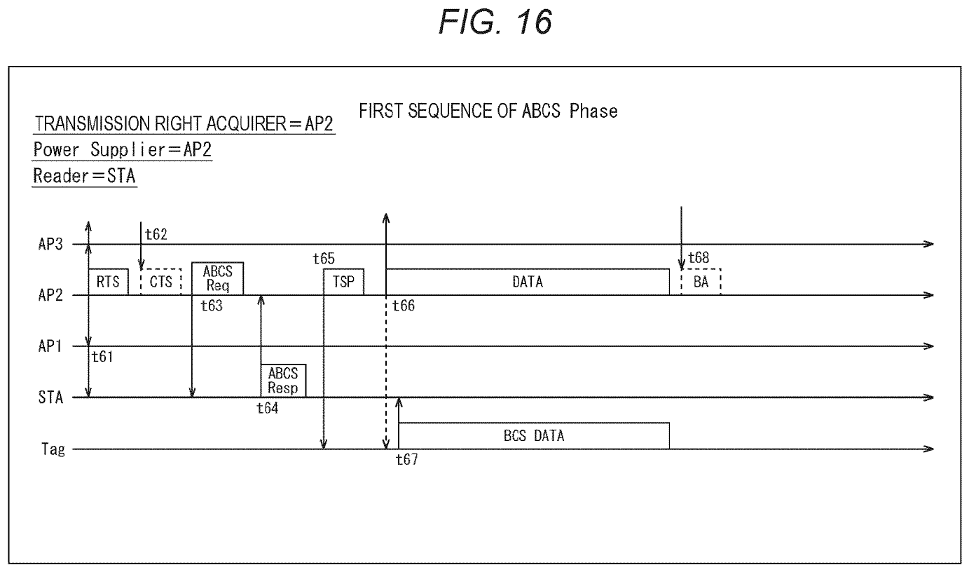

That is, in the ABCS Phase, the communication devices in charge of the Power Supplier and the Reader change on the basis of a plurality of pieces of reception quality information indicating the reception quality measured in Training Phase, and thus, the operation sequence greatly changes. A detailed sequence will be described below with reference to FIGS. 16 to 19.

### <ABCS Operating Mode Notification Frame>

FIG. 6 is a diagram illustrating a configuration example of an ABCS Operating Mode Notification frame.

In FIG. 6, the ABCS Operating Mode Notification frame includes fields of Category, Action, Dialog Token, and ABCS Operating Mode Notification. Note that, in FIG. 6, the hatched portions are portions relating to the new technique different from the conventional technique. Similarly, in the following drawings illustrating the configuration of the frame, the hatched portions indicate portions relating to the new technique different from the conventional technique.

The field of Category includes information indicating that the present Action frame is an ABCS-related frame.

The Action is used in combination with the Category. The field of Action includes information indicating that the present Action frame is the ABCS Operating Mode Notification frame.

The field of Dialog Token includes information indicating a processing number of the present Action frame.

The field of ABCS Operating Mode Notification includes fields of Tag ID, ABCS Interval, and DATA Duration.

The field of Tag ID includes identification information of a transmission-side Tag of the BCS DATA. The identification information may be a MAC address or identification information that can be managed by the AP.

The field of ABCS Interval includes information indicating a time interval at which the BCS DATA is to be acquired (received) from the Tag. For example, in a case where the ABCS Interval is set to an interval of 100 ms, an operation of starting the ABCS communication to receive the BCS DATA from the Tag when a time passes around 100 ms from the previous BCS DATA reception timing is performed.

Note that the field of ABCS Interval may indicate a numerical value or may indicate index information based on a table defined in the standard.

The field of DATA Duration includes information indicating a time length of the BCS DATA. The communication device in charge of the Power Supplier needs to transmit at least a signal having a time length equal to or longer than the time length indicated in the field of DATA Duration.

Note that the ABCS Operating Mode Notification frame in FIG. 6 is configured on the basis of an Action frame of IEEE802.11ax. The ABCS Operating Mode Notification frame of the present technology is not limited to the configuration of FIG. 6, and it is sufficient that at least the above-described information is included.

Furthermore, in FIG. 6, the ABCS Capability Element frame is configured on the assumption of a MAC frame, but may be configured on the assumption of a TCP/IP frame as long as the above-described information is included. These matters similarly apply to the following frame configurations.

### <First Sequence in Training Phase>

FIG. 7 is a diagram illustrating a first sequence in the Training Phase.

FIG. 7 illustrates a sequence in a case where each AP is a Power Supplier candidate and the STA is a Reader candidate. FIG. 7 illustrates a sequence of Power Supplier (PS) Selection in which the reception quality of each (each AP) of the plurality of Power Supplier candidates is measured for one Reader candidate (STA).

Note that FIG. 7 illustrates a sequence in a case where the AP1 acquires the transmission right and starts the processing. However, for example, an operation that another AP or the STA acquires the transmission right and requests the AP1 to perform similar processing may be performed. Note that the communication device that has acquired the transmission right is hereinafter referred to as a transmission right acquirer.

Furthermore, in FIG. 7, a solid rectangle indicates a signal to be transmitted, and a dashed rectangle indicates a signal to be received.

At timing t21, the AP1 transmits a Multi-User RTS frame (hereinafter referred to as an RTS frame (RTS in the drawing)) to the STA to which the reception quality measurement of the BCS DATA is to be requested, other APs (the AP2 and the AP3) that are the Power Supplier candidates, and other surrounding communication devices (not illustrated). The AP2, the AP3, the STA, and other communication devices receive the RTS frame transmitted from the AP1.

Note that, in FIG. 7, arrows above the horizontal axis of the AP3 represent transmission from the target communication device to other communication devices. Furthermore, in FIG. 7, an arrow above the horizontal axis of the AP3 represents transmission from another communication device to the target communication device. The same similarly applies to the subsequent drawings illustrating sequences.

At timing t22, another communication device transmits the CTS frame to the AP1. The AP1 receives the CTS frame transmitted from another communication device. At this time, although illustration of arrows is omitted, the AP2, the AP3, and the STA also transmit the CTS frame to the AP1. The AP1 also receives the CTS frames transmitted from the AP2, the AP3, and the STA. The same similarly applies to the subsequent drawings illustrating sequences.

At timing t23, the AP1 transmits, to the AP2 and the AP3, a Coordination Request frame (Coor. Req. in the drawing) that is a coordinated measurement request signal for requesting another AP to measure the reception quality in a coordinated manner. The AP2 and the AP3 receive the Coordination Request frame.

At timing t24, the AP2 and the AP3 transmit a Coordination Response frame (Coor. Resp. in the drawing) to the AP1 as a coordinated measurement response signal to the received Coordination Request frame. The AP1 receives the Coordination Response frame transmitted from the AP2 and the Coordination Response frame transmitted from the AP3.

Note that processing at timing t23 and t24 is setting processing for measuring the reception quality in a coordinated manner, and is referred to as TXOP Sharing Setting.

At timing t25, the AP1 transmits a TRN Request frame (TRN Req. in the drawing), which is a measurement request signal for requesting measurement of the reception quality, to the STA, and notifies the STA of information regarding the reception quality measurement for the BCS DATA. The information regarding the reception quality measurement for the BCS DATA includes, for example, information for setting the STA as the Reader. The STA receives the TRN Request frame.

At timing t26, the AP1 transmits the TSP, which is a signal that allows the Tag to transmit the BCS DATA, to the Tag. The Tag receives the TSP, and checks that the TSP includes its own identification information and that training is to be performed.

At timing t27, the AP1 starts transmitting the data signals (DATA in the drawing) to another communication device. Note that this data signal may be a carrier wave. The Tag receives the data signal (the dashed arrow in the drawing) transmitted from the AP1 to another communication device.

At timing t28, the Tag transmits training BCS DATA (Training Sequence (TRN Seq. in the drawing)), which is a backscatter signal to which a known symbol is added, to the STA. The STA receives the training BCS DATA transmitted from the Tag, and measures a Bit Error Rate (BER) or a Signal to Interference and Noise Ratio (SINR), which is the reception quality. Note that, if possible, the timing t27 and t28 may be the same timing. Thereafter, similarly, DATA reception timing and TRN Seq transmission timing may be the same.

At timing t29, the AP2 starts transmitting the data signal to another communication device. The Tag receives the data signal (the dashed arrow in the drawing) transmitted from the AP2 to another communication device, as illustrated with the dashed arrow.

At timing t30, the Tag transmits the training BCS DATA, which is the backscatter signal to which a known symbol is added, to the STA. The STA receives the training BCS DATA transmitted from the Tag, and measures the BER or the SINR that is the reception quality.

At timing t31, the AP3 starts transmitting the data signal to another communication device. The Tag receives the data signal (the dashed arrow in the drawing) transmitted from the AP3 to another communication device, as illustrated with the dashed arrow.

At timing t32, the Tag transmits the training BCS DATA, which is the backscatter signal to which a known symbol is added, to the STA. The STA receives the training BCS DATA transmitted from the Tag, and measures the BER or the SINR that is the reception quality.

At timing t33, the STA, which has completed all the measurements, transmits a TRN Response frame (TRN Resp. in the drawing), which is a measurement response signal including the reception quality information indicating the measured reception quality, to the AP1. The AP1 receives the TRN Response frame and obtains all pieces of the reception quality information.

As a result, the AP1 as the transmission right acquirer can determine the communication device in charge of the Power Supplier in the ABCS Phase, using all pieces of the reception quality information.

That is, the AP1 determines whether or not there is an appropriate AP as the communication device in charge of the Power Supplier on the basis of all pieces of reception quality information. In a case where it is determined that there is an appropriate AP (for example, the AP2) as the communication device in charge of the Power Supplier, the AP1 transmits, to the AP2 and the STA, an ABCS Setup frame that is a setting signal for setting the role including identification information of the AP2 at timing t34. The AP2 and the STA receive the ABCS Setup frame.

At timing t35, the AP2 and the STA transmit an ACK frame that is a reception confirmation response signal to the ABCS Setup frame. The AP1 receives the ACK frame transmitted from the AP2 and the ACK frame transmitted from the STA. Thereafter, the sequence of FIG. 7 ends.

Note that the sequence in the Training Phase is not limited to the sequence in FIG. 7. For example, the STA may transmit some response signal (for example, a Block ACK frame or the like) after receiving the TRN Request frame. Furthermore, the STA may transmit a TRN Response frame after receiving some inductive signal (for example, a Trigger frame or the like) from the AP1.

Furthermore, the STA may measure the reception quality in a state where a special function (for example, NOMA, Coor (Coordination)-BF (beamforming), or beam steering) is performed. In this case, there may be some instruction from the AP1 to the STA about implementation of the special function or the like.

Moreover, before the start of transmission of the data signals of the AP2 and the AP3, the AP1 may transmit some inductive signal (such as Trigger) to the AP2 and the AP3.

Furthermore, in the ABCS Setup frame, a plurality of pieces of information regarding the candidate Power Suppliers may be selected and included. Furthermore, each AP does not necessarily transmit the data signal, and may transmit a carrier wave having no information, for example.

Moreover, in FIG. 7, one STA measures the reception quality, but a plurality of STAs may perform the measurement. In this case, a plurality of STAs may be designated in a Reader ID in an ABCS Request frame to be described below.

Note that, in the present embodiment, an example in which the communication device that plays each role is determined by the transmission right acquirer will be described below. However, in a case where a server (not illustrated) is included in the wireless communication system, the communication device that plays each role may be determined by the server or the like.

### <Second Sequence in Training Phase>

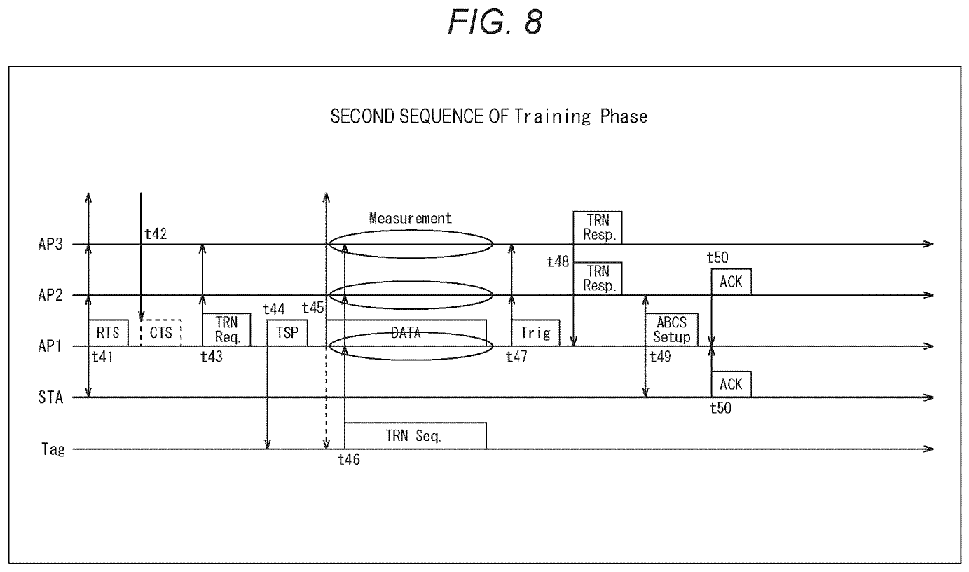

FIG. 8 is a diagram illustrating a second sequence in the Training Phase.

The second sequence of FIG. 8 is different from the first sequence of FIG. 7 in that when the AP1 is the Power Supplier candidate, the other APs are the Reader candidates. That is, FIG. 8 illustrates a sequence of Reader Selection in which the reception quality of each (each AP) of the plurality of Reader candidates is measured for one Power Supplier candidate (AP1).

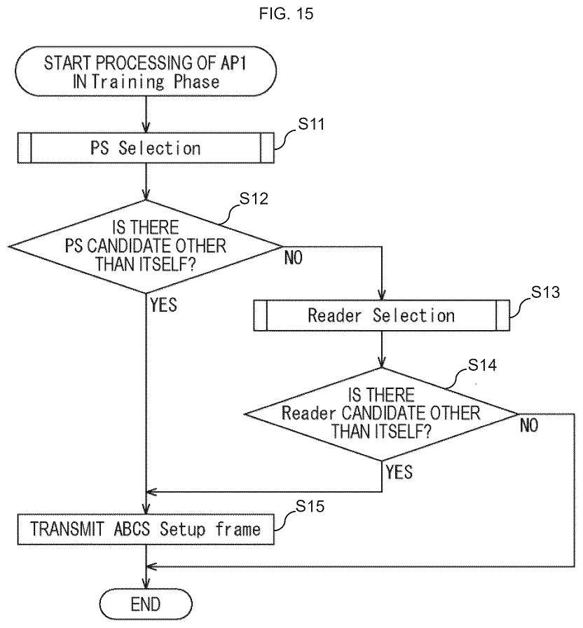

Note that the second sequence of FIG. 8 is performed in a case where there is no Power Supplier candidate with good-measured reception quality other than the AP1 in the first sequence of FIG. 7, which will be described below with reference to FIG. 15, for example. Certainly, only the second sequence may be performed alone.

At timing t41, the AP1 transmits the RTS frame to the STA, the AP2 and the AP3 to which the reception quality measurement of the BCS DATA is to be requested, and another communication device. The AP2, the AP3, the STA, and other communication devices receive the RTS frame transmitted from the AP1.

At timing t42, the AP2, the AP3, the STA, and another communication device transmit the CTS frame to the AP1. The AP1 receives the CTS frame transmitted from the AP2, the AP3, the STA, and another communication device.

At timing t43, the AP1 transmits the TRN Request frame, which is the measurement request signal for requesting measurement of the reception quality, to the AP2 and the AP3, and notifies the AP2 and the AP3 of information regarding the reception quality measurement for the BCS DATA. In the case of FIG. 8, the information regarding the reception quality measurement for the BCS DATA includes, for example, information for setting each AP as the Reader.

At timing t44, the AP1 transmits the TSP to the Tag. The Tag receives the TSP, and checks that the TSP includes its own identification information and that training is to be performed.

At timing t45, the AP1 starts transmitting the data signal to another communication device. The Tag receives the data signal (the dashed arrow in the drawing) transmitted from the AP1 to another communication device.

At timing t46, the Tag transmits the training BCS DATA, which is the backscatter signal to which a known symbol is added, to the AP1 to AP3. Each of the AP1 to AP3 receives the training BCS DATA transmitted from the Tag, and measures the BER or the SINR that is the reception quality. Each of the AP1 to AP3 acquires the reception quality information indicating the measured reception quality.

At timing t47, the AP1 transmits the Trigger frame, which is an inductive signal that induces transmission of the reception quality information to itself, to the AP2 and the AP3. The AP2 and the AP3 receive the Trigger frame.

At timing t48, the AP2 and the AP3 transmit the TRN Response frame including the reception quality information to the AP1. The AP1 receives the reception quality information transmitted from the AP2 and the reception quality information transmitted from the AP3. As a result, the AP1 as the transmission right acquirer can determine the communication device in charge of the Reader in the ABCS Phase on the basis of the plurality of pieces of reception quality information.

The AP1 determines whether or not there is an appropriate AP as the communication device in charge of the Reader on the basis of the plurality of pieces of received reception quality information. For example, in a case where the AP1 determines that the AP2 is appropriate as the communication device in charge of the Reader, the AP1 transmits the ABCS Setup frame including the identification information of the corresponding AP2 to the AP2 and the STA at timing t49.

At timing t50, the AP2 and the STA transmit the ACK frame that is a reception confirmation response signal to the ABCS Setup frame. The AP1 receives the ACK frame transmitted from the AP2 and the ACK frame transmitted from the STA. Thereafter, the sequence of FIG. 8 ends.

Note that the sequence in the Training Phase is not limited to the sequence in FIG. 8. Furthermore, a plurality of the Reader candidates may be selected and included in the ABCS Setup frame.

Furthermore, the AP1 does not necessarily transmit the data signal, and may transmit a carrier wave having no information, for example.

### <Configuration of Coordination Request Frame>

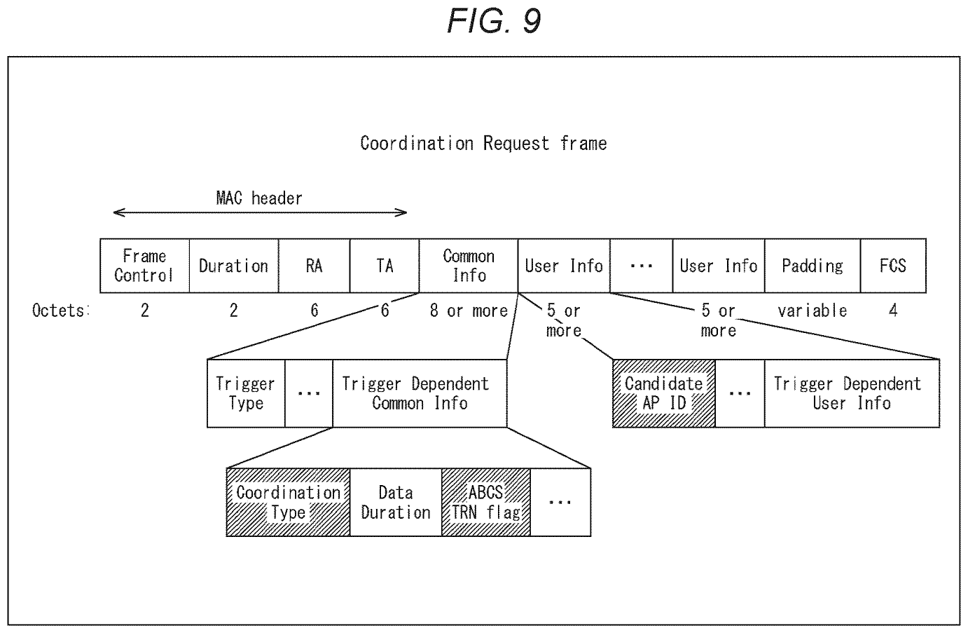

FIG. 9 is a diagram illustrating a configuration example of the Coordination Request frame.

The Coordination Request frame in FIG. 9 includes fields of Frame Control, Duration, Receiver Address (RA), Transmitter Address (TA), Common Info, User Info, User Info, Padding, and Frame Check Sequence (FCS). The Frame Control to TA are MAC Header.

The field of Frame Control includes information indicating that the present frame is the Coordination Request frame.

The field of Duration includes information indicating a transmission time of the present frame.

The field of RA includes MAC address information of a transmission destination of the frame.

The field of TA includes MAC address information of a transmission side (transmission source) of the frame.

The field of Common Info includes fields of Trigger Type, . . . , and Trigger Dependent Common Info.

The field of Trigger Type includes information indicating that the present frame is a Coordination Request frame and the present frame includes a Trigger Dependent Common Info field.

The field of Trigger Dependent Common Info includes the fields of Coordination Type, DATA Duration, ABCS TRN flag, and the like.

The field of Coordination Type includes information indicating a candidate of a coordinated transmission method. In the case of FIG. 7, information regarding TXOP Sharing is included.

The field of DATA Duration includes information regarding a transmission time of the data signal.

The field of ABCS TRN flag includes flag information indicating whether or not to train the BCS DATA in the ABCS.

The field of User Info includes fields of Candidate AP ID, . . . , and Trigger Dependent User Info.

The field of Candidate AP ID includes identification information of the AP that is a coordination candidate for measuring the reception quality in a coordinated manner. The identification information may be a MAC address, a BSS Color, or a number determined in advance between the APs.

The field of Trigger Dependent User Info includes information regarding the AP that is a coordination candidate.

Note that the Coordination Request frame in FIG. 9 is configured on the basis of a Trigger frame of IEEE802.11ax. The Coordination Request frame of the present technology is not limited to the configuration of FIG. 9, and may include at least the above-described information.

Furthermore, in FIG. 9, the Coordination Request frame is configured on the assumption of a MAC frame, but may be configured on the assumption of a TCP/IP frame as long as the above-described information is included.

### <Coordination Response Frame>

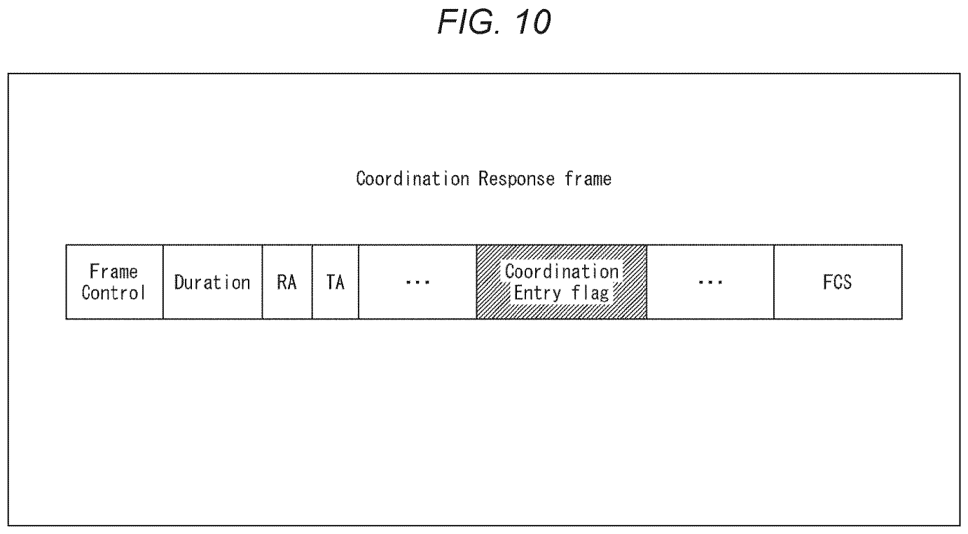

FIG. 10 is a diagram illustrating a configuration example of the Coordination Response frame.

In FIG. 10, the Coordination Response frame includes fields of Frame Control, Duration, RA, TA, . . . , Coordination Entry flag, . . . , and FCS.

The field of Frame Control includes information indicating that the present frame is the Coordination Response frame.

The field of Duration includes information indicating a transmission time of the present frame.

The field of RA includes MAC address information of a transmission destination of the frame.

The field of TA includes MAC address information of the transmission side of the frame.

The field of Coordination Entry flag includes information indicating whether or not coordinated transmission is possible.

The field of FCS includes an error detection code.

Note that the Coordination Response frame in FIG. 10 is configured on the basis of the Trigger frame of IEEE802.11ax. The Coordination Response frame of the present technology is not limited to the configuration of FIG. 10, and may include at least the above-described information.

Furthermore, in FIG. 10, the Coordination Response frame is configured on the assumption of a MAC frame, but may be configured on the assumption of a TCP/IP frame as long as the above-described information is included.

### <Configuration of ABCS TRN Request Frame>

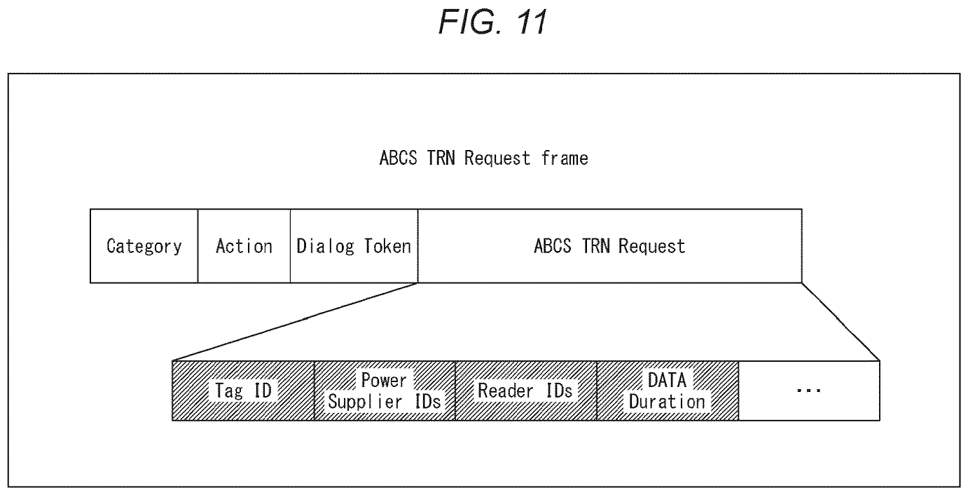

FIG. 11 is a diagram illustrating a configuration example of an ABCS TRN Request frame.

In FIG. 11, the ABCS TRN Request frame is different from the ABCS Operating Mode Notification frame in FIG. 11 in that the ABCS Operating Mode Notification field is replaced with an ABCS TRN Request field.

In FIG. 11, the ABCS TRN Request frame includes fields of Category, Action, Dialog Token, and ABCS TRN Request.

The field of Category includes information indicating that the present Action frame is an ABCS-related frame.

The Action is used in combination with the Category. The field of Action includes information indicating that the present Action frame is the ABCS TRN Request frame.

The field of Dialog Token includes information indicating a processing number of the present Action frame.

The field of ABCS TRN Request includes fields of Tag ID, Power Supplier IDs, Reader IDs, and DATA Duration.

The field of Tag ID includes identification information of a transmission-side Tag of the BCS DATA. The identification information may be a MAC address or identification information that can be managed by the AP.

The field of Power Supplier IDs includes identification information of the communication device in charge of the Power Supplier that transmits a signal necessary for generating the training BCS DATA. The identification information of the communication device in charge of the Power Supplier may be a MAC address, an Association ID (AID), identification information that can be managed by the AP, or the like.

Furthermore, the field of Power Supplier IDs may be extended so that the communication devices in charge of a plurality of Power Suppliers can be designated. In this case, the field of Power Supplier IDs may include information indicating a total number of communication devices in charge of the Power Suppliers.

The field of Reader IDs includes identification information of the communication device in charge of the Reader that receives the training BCS DATA and measures the reception quality. The identification information of the communication device in charge of the Reader may also be a MAC address, an AID, identification information that can be managed by the AP, or the like.

Furthermore, the field of Reader IDs may be extended so that the communication devices in charge of a plurality of Readers can be designated. In this case, the field of Reader IDs may include information indicating a total number of communication devices in charge of the Readers.

The field of DATA Duration includes information indicating a time length of the BCS DATA.

### <Configuration of ABCS TRN Response Frame>

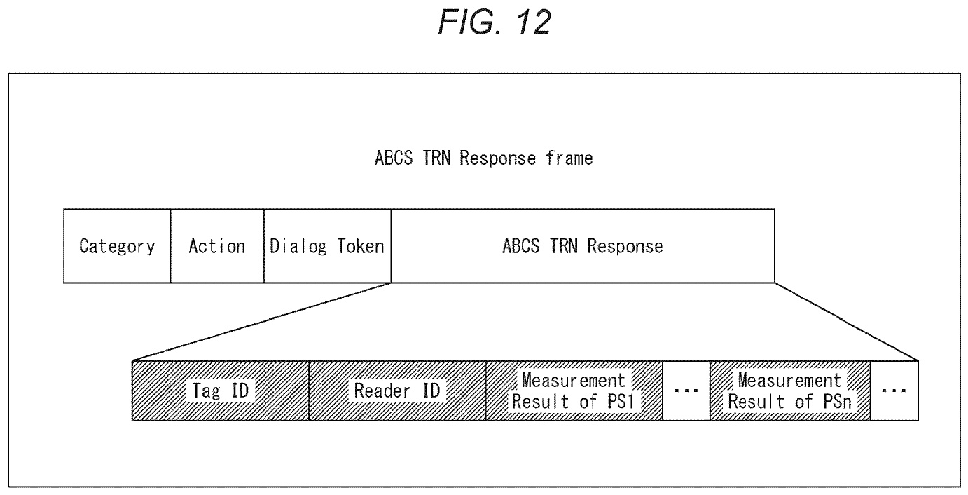

FIG. 12 is a diagram illustrating a configuration example of an ABCS TRN Response frame.

In FIG. 12, the ABCS TRN Response frame is different from the ABCS Operating Mode Notification frame in FIG. 6 in that the ABCS Operating Mode Notification field is replaced with an ABCS TRN Response field.

In FIG. 12, the ABCS TRN Response frame includes fields of Category, Action, Dialog Token, and ABCS TRN Response.

The field of Category includes information indicating that the present Action frame is an ABCS-related frame.

The Action is used in combination with the Category. The field of Action includes information indicating that the present Action frame is the ABCS TRN Response frame.

The field of Dialog Token includes information indicating a processing number of the present Action frame.

The field of ABCS TRN Response includes fields of Tag ID, Reader ID, Measurement Result of PS1, . . . , Measurement Result of PSn, and the like.

The field of Tag ID includes identification information of a transmission-side Tag of the BCS DATA. The identification information may be a MAC address or identification information that can be managed by the AP.

The field of Reader ID includes identification information of the communication device in charge of the Reader that receives the training BCS DATA and measures the reception quality. The identification information of the communication device in charge of the Reader may be a MAC address, an Association ID (AID), identification information that can be managed by the AP, or the like.

The field of Measurement Result of PSn includes the reception quality information indicating the reception quality of the BCS DATA based on the signal from the communication device in charge of an n-th Power Supplier. The reception quality information may be the BER or the SINR, or may be both pieces of the information. Note that the order of the Power Suppliers is the order specified in the ABCS TRN Request frame.

### <Configuration Example of TSP>

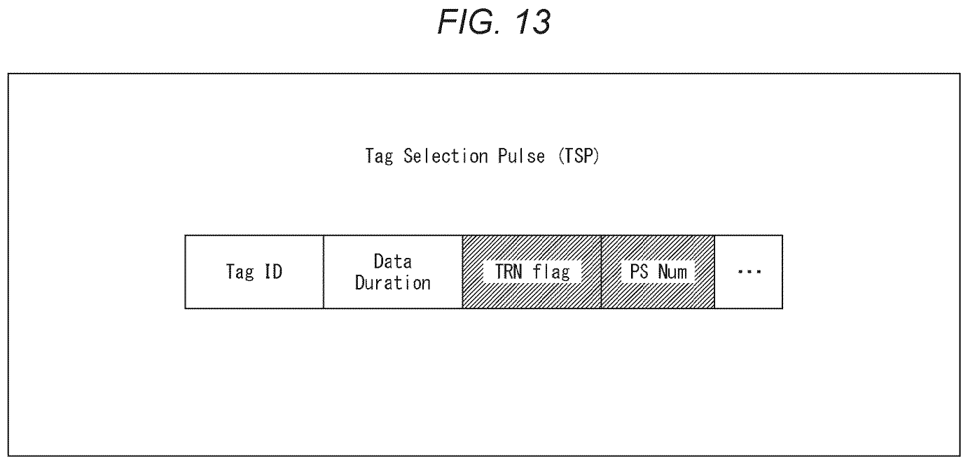

FIG. 13 is a diagram illustrating a configuration example of the TSP.

In FIG. 13, the TSP includes fields of Tag ID, DATA Duration, TRN flag, and PS Num.

The TSP in FIG. 13 assumes that information is transmitted as a PHY signal in the form of a symbol stream, and a specific modulation and coding method of the TSP depends on a communication standard of the backscatter signal.

The field of Tag ID includes identification information of a transmission-side Tag of the BCS DATA. The identification information may be a MAC address or identification information that can be managed by the AP.

The field of DATA Duration includes information indicating a time length of the BCS DATA.

The field of TRN Flag includes information indicating whether or not to transmit a known signal for training. In a case where the field of TRN Flag is “1”, the Tag transmits the BCS DATA in a form of adding known sequence information to a subsequent signal. In a case where the field of TRN Flag is “0”, the Tag transmits the BCS DATA in a form of adding its own information to be transmitted (for example, sensor data or the like).

The field of PS Num includes information indicating the number of Power Suppliers to be trained.

### <Configuration of ABCS Setup Frame>

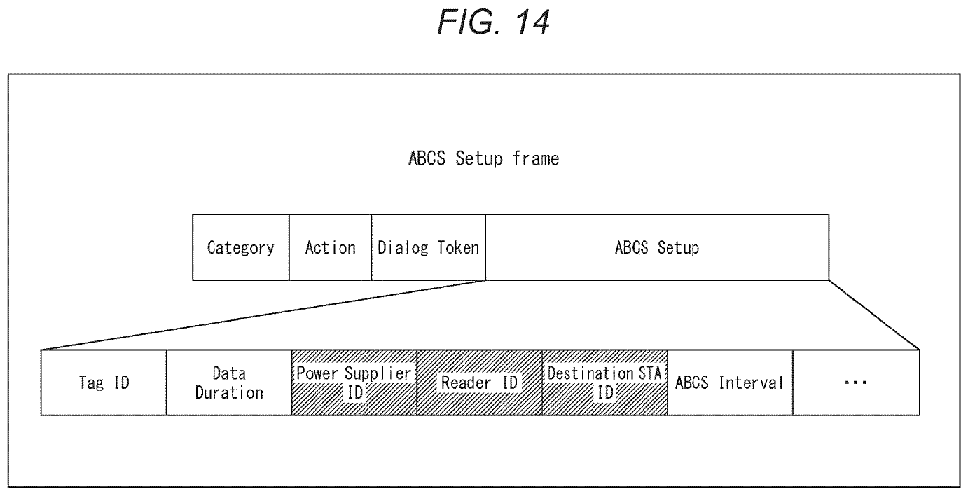

FIG. 14 is a diagram illustrating a configuration example of the ABCS Setup frame.

In FIG. 14, the ABCS Setup frame is different from the ABCS Operating Mode Notification frame in FIG. 6 in that the ABCS Operating Mode Notification field is replaced with an ABCS Setup field.

In FIG. 14, the ABCS Setup frame includes fields of Category, Action, Dialog Token, and ABCS Setup.

The field of Category includes information indicating that the present Action frame is an ABCS-related frame.

The Action is used in combination with the Category. The field of Action includes information indicating that the present Action frame is the ABCS Setup frame.

The field of Dialog Token includes information indicating a processing number of the present Action frame.

The field of ABCS Setup includes fields of Tag ID, DATA Duration, Power Supplier ID, Reader ID, Destination STA ID, ABCS Inerval, and the like.

The field of Tag ID includes identification information of a transmission-side Tag of the BCS DATA. The identification information may be a MAC address or identification information that can be managed by the AP.

The field of DATA Duration includes information indicating a time length of the BCS DATA. Note that the Power Supplier needs to transmit a signal having a time length equal to or longer than the time length indicated in the DATA Duration.

The field of Power Supplier ID includes identification information of the communication device in charge of the Power Supplier that transmits a signal necessary for generating the BCS DATA. The identification information of the Power Supplier may be a MAC address, an Association ID (AID), identification information that can be managed by the AP, or the like.

The field of Reader ID includes identification information of the communication device in charge of the Reader that receives the BCS DATA. The identification information of the Reader may also be a MAC address, an Association ID (AID), identification information that can be managed by the AP, or the like.

The field of Destination STA ID includes identification information of the STA that requests the BCS DATA. The identification information of the STA requesting the BCS DATA is information valid when the Reader is an AP other than the AP1. The identification information of the STA requesting the BCS DATA may also be a MAC address, an AID, or identification information that can be managed by the AP, or the like.

The field of ABCS Interval includes information indicating a time interval at which the BCS DATA is to be acquired (received) from the Tag. For example, in a case where the interval is set to 100 ms, an operation of starting the ABCS to receive the BCS DATA from the Tag when the time passes for 100 ms or more from the previous BCS DATA reception timing is performed.

Note that the field of ABCS Interval may indicate a numerical value or may indicate index information based on a table defined in the standard.

### <Processing of AP1 in Training Phase>

FIG. 15 is a flowchart for describing processing of the AP1 in the Training Phase.

Note that the processing of FIG. 15 is executed by each unit of the wireless communication unit 21 that is controlled by the communication control unit 35 of the communication device 11 of FIG. 2 that operates as the AP1.

In step S11, the communication control unit 35 performs the above-described PS Selection (training) with reference to FIG. 7.

In step S12, the communication control unit 35 determines whether or not there is a Power Supplier (PS) candidate other than itself. Note that, for example, whether or not there is a Power Supplier candidate may be determined depending on whether or not the measured reception quality exceeds a predetermined standard. In a case where it is determined in step S12 that there is no Power Supplier candidate other than itself, the processing proceeds to step S13.

In step S13, the communication control unit 35 performs the above-described Reader Selection (training) with reference to FIG. 8.

In step S14, the communication control unit 35 determines whether or not there is a Reader candidate other than itself. Note that, for example, whether or not there is a Reader candidate may be determined according to whether or not the measured reception quality exceeds a predetermined standard. In a case where it is determined in step S14 that there is no Reader candidate other than itself, the processing of FIG. 15 ends.

On the other hand, in a case where an optimal Power Supplier candidate other than itself is found in the PS Selection, it is determined in step S12 that there is a Power Supplier candidate other than itself, and the processing proceeds to step S15.

In this case, in step S15, the communication control unit 35 transmits the ABCS Setup in which the identification information of the AP that is the Power Supplier candidate is included in the Power Supplier ID to the AP that is the Power Supplier candidate. At this time, the communication control unit 35 may set a plurality of communication devices having the measured reception quality exceeding a predetermined standard as the Power Supplier candidates, or may set one communication device having the best measured reception quality as the Power Supplier candidate.

Thereafter, the processing of FIG. 15 ends.

Furthermore, in a case where an optimal Reader candidate other than itself is found in the Reader Selection, it is determined in step S14 that there is a Reader candidate other than itself, and the processing proceeds to step S15.

In this case, in step S15, the communication control unit 35 transmits the ABCS Setup including the identification information of the AP that is the Reader candidate in the Reader ID to the AP that is the Reader candidate. At this time, the communication control unit 35 may set a plurality of communication devices exceeding a predetermined standard as the Reader candidates, or may set one communication device having the best measured reception quality as the Reader candidate.

Thereafter, the processing of FIG. 15 ends.

### <Details of ABCS Phase>

As described above, the sequence of the ABCS Phase is different depending on which communication device is in charge of each of the transmission right acquirer, the Power Supplier, and the Reader. Note that, in any sequence, the STA desires to acquire the BCS DATA, and the STA directly or indirectly acquires the BCS DATA. Hereinafter, each sequence example will be described.

### <First Sequence of ABCS Phase>

FIG. 16 is a diagram illustrating a first sequence of the ABCS Phase.

FIG. 16 illustrates the first sequence in a case where the communication devices in charge of the transmission right acquirer, the Power Supplier, and the Reader are the AP2, the AP2, and the STA, respectively.

At timing t61 in FIG. 16, the AP2 in charge of the transmission right acquirer transmits the RTS frame to each of the surrounding AP1 and AP3, the STA on the reception side of the BCS DATA, and another communication device (not illustrated). The AP1, the AP3, the STA, and another communication device receives the RTS frame.

At timing t62, the AP1, the AP3, the STA, and another communication device transmit the CTS frame to the AP2. The AP2 receives the CTS frame transmitted from the AP1, the AP3, the STA, and another communication device.

At timing t63, the AP2 transmits the ABCS Request frame to the STA, and notifies the STA of information regarding the Tag, the Power Supplier, and the Reader. The ABCS Request frame is a role request signal for requesting execution of at least one role of the Power Supplier or the Reader. The STA receives the ABCS Request frame.

At timing t64, the STA determines its own operation on the basis of the ABCS Request frame, and transmits an ABCS Response frame, which is a response signal to the ABCS Request frame, to the AP2. The ABCS Response frame includes information indicating whether or not the operation in the requested role is possible.

After receiving the ABCS Response frame as a response signal from the STA, the AP2 transmits the TSP to the Tag at timing t65.

The Tag that has received the TSP checks that its own identification information is included in the TSP.

At timing t66, the AP2 starts transmitting the data signal to another communication device.

The Tag receives the data signal (the dashed arrow in the drawing) transmitted from the AP2 to another communication device, and transmits the BCS DATA, which is the backscatter signal to which data information to be transmitted is added, to the STA at timing t67. The STA receives the BCS DATA transmitted from the Tag.

Meanwhile, another communication device, which has received the data signal transmitted from the AP, transmits the Block ACK frame (BA in the drawing), which is a reception confirmation response signal, to the AP2 at timing t68. Thereafter, the first sequence of FIG. 16 ends.

Note that, in the first sequence, a case in which the AP2 and the STA can directly exchange information is described. However, the AP1 may operate to relay the signals transmitted from the AP2 and the STA, depending on the situation (for example, when the AP2 and the STA are spatially separated, and the signals cannot be detected from each other, or the like). The same similarly applies to the subsequent sequences.

### <Second Sequence of ABCS Phase>

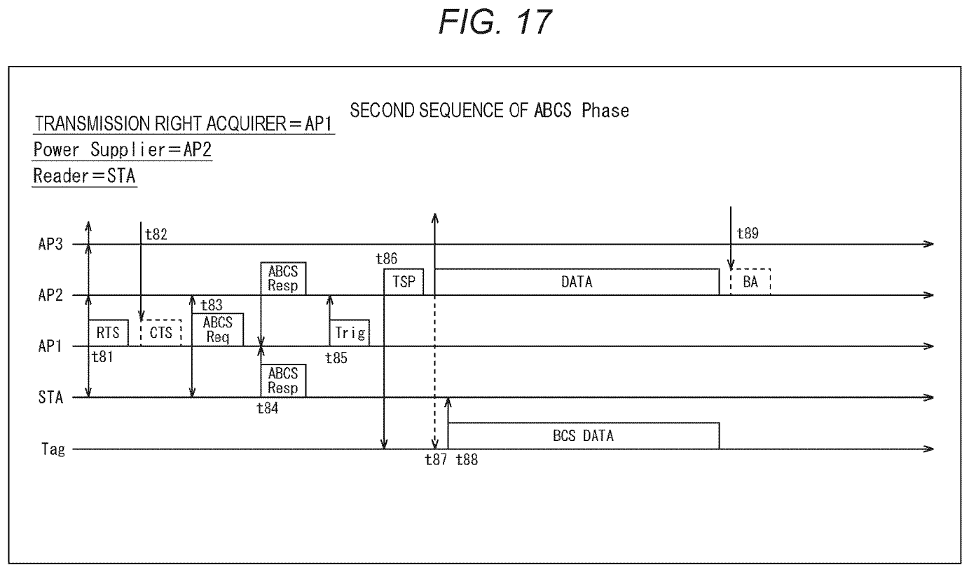

FIG. 17 is a diagram illustrating a second sequence of the ABCS Phase.

FIG. 17 illustrates the second sequence in a case where the communication devices in charge of the transmission right acquirer, the Power Supplier, and the Reader are the AP1, the AP2, and the STA, respectively.

At timing t81 in FIG. 17, the AP1 as the transmission right acquirer transmits the RTS frame to each of the surrounding AP2 and AP3, the STA in charge of the Reader, and another communication device (not illustrated). The AP2, the AP3, the STA, and another communication device receives the RTS frame.

At timing t82, the AP2, the AP3, the STA, and another communication device transmit the CTS frame to the AP1. The AP1 receives the CTS frame transmitted from the AP2, the AP3, the STA, and another communication device.

At timing t83, the AP1 transmits the ABCS Request frame to the AP2 and the STA, and notifies the AP2 and the STA of information regarding the Tag, the Power Supplier, and the Reader. The AP2 and the STA receive the ABCS Request frame.

At timing t84, the AP2 and the STA determine its own operation on the basis of the ABCS Request frame, and transmit the ABCS Response frame, which is a response signal to the ABCS Request frame, to the AP1.

After receiving the ABCS Response frame as a response signal from the STA, the AP1 transmits a Trigger signal to the AP2 at timing t85 to permit sharing of the transmission right. That is, the Trigger signal includes information indicating permission to share the transmission right.

The AP2, which has received the Trigger signal, transmits the TSP to the Tag at timing t86.

The Tag that has received the TSP checks that its own identification information is included in the TSP.

At timing t87, the AP2 starts transmitting the data signal (or a carrier wave) to another communication device.

The Tag receives the data signal (the dashed arrow in the drawing) transmitted from the AP2 to another communication device, and transmits the BCS DATA, which is the backscatter signal to which data information to be transmitted is added, to the STA at timing t88. The STA receives the BCS DATA.

Meanwhile, another communication device, which has received the data signal transmitted from the AP2, transmits the BA, which is a reception confirmation response signal, to the AP2 at timing t89.

The AP2 receives the BA. Thereafter, the second sequence of FIG. 17 ends.

### <Third Sequence of ABCS Phase>

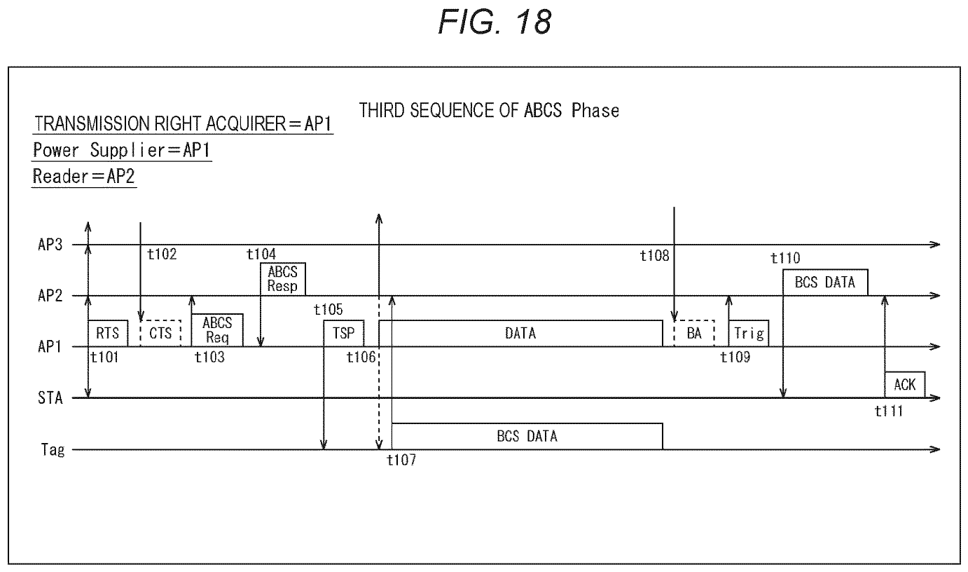

FIG. 18 is a diagram illustrating the third sequence of the ABCS Phase.

FIG. 18 illustrates the third sequence in a case where the communication devices in charge of the transmission right acquirer, the Power Supplier, and the Reader are the AP1, the AP1, and the AP2, respectively.

At timing t101 in FIG. 18, the AP1 as the transmission right acquirer transmits the RTS frame to each of the surrounding AP2, AP3, STA, and another communication device. The AP2, the AP3, the STA, and another communication device receives the RTS frame.

At timing t102, the AP2, the AP3, the STA, and another communication device transmit the CTS frame to the AP1. The AP1 receives the CTS frame transmitted from the AP2, the AP3, the STA, and another communication device.

At timing t103, the AP1 transmits the ABCS Request frame to the AP2 who is in charge of the Reader, and notifies the AP2 of information regarding the Tag, the Power Supplier, and the Reader. The AP2 receives the ABCS Request frame.

At timing t104, the AP2 determines its own operation on the basis of the ABCS Request frame, and transmits the ABCS Response frame, which is a response signal to the ABCS Request frame, to the AP1.

After receiving the ABCS Response frame as a response signal from the AP2, the AP1 transmits the TSP to the Tag at timing t105.

The Tag that has received the TSP checks that its own identification information is included in the TSP.

At timing t106, the AP1 starts transmitting the data signal to another communication device.

The Tag receives the data signal (the dashed arrow in the drawing) transmitted from the AP1 to another communication device, and transmits the BCS DATA, which is the backscatter signal to which data information to be transmitted is added, to the AP2 at timing t107. The AP2 receives the BCS DATA.

Meanwhile, another communication device, which has received the data signal transmitted from the AP1, transmits the BA, which is a reception confirmation response signal, to the AP1 at timing t108.

The AP1, which has received the BA, transmits the Trigger signal to the AP2 at timing t109 and permits sharing of the transmission right.

The AP2, which has received the Trigger signal, transmits the BCS DATA to the STA at timing t110. The STA can indirectly acquire the BCS DATA by receiving the BCS DATA transmitted from the AP2.

At timing t111, the STA transmits the ACK frame, which is a reception confirmation response signal of the BCS DATA, to the AP2. The AP2 receives the ACK frame. Thereafter, the third sequence of FIG. 18 ends.

Note that, in the third sequence, the AP1 does not necessarily need to share the transmission right with the AP2. In this case, the AP2 transmits the received BCS DATA to the STA when next time the AP2 acquires the transmission right. In a case where it is not necessary to worry about a delay due to communication of the BCS DATA, the method of transmitting the BCS DATA to the STA at the next time of acquisition of the transmission right as described above may be performed.

### <Fourth Sequence of ABCS Phase>

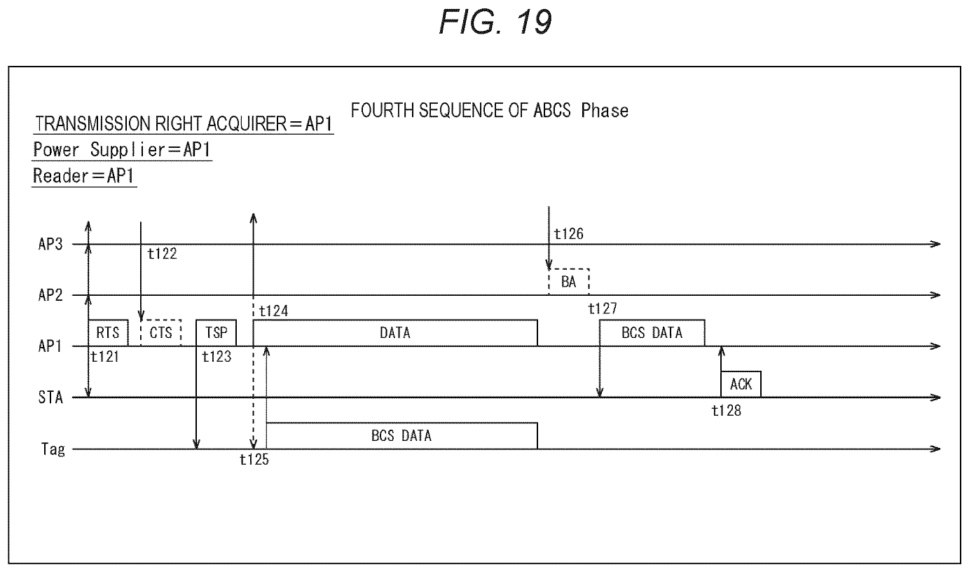

FIG. 19 is a diagram illustrating a fourth sequence of the ABCS Phase.

FIG. 19 illustrates the fourth sequence in a case where the communication devices in charge of the transmission right acquirer, the Power Supplier, and the Reader are all AP1s.

At timing t121 in FIG. 19, the AP1 in charge of the transmission right acquirer transmits the RTS frame to each of the surrounding AP2 and AP3, the STA on the reception side of the BCS DATA, and another communication device. The AP2, the AP3, the STA, and another communication device receives the RTS frame.

At timing t122, the AP2, the AP3, the STA, and another communication device transmit the CTS frame to the AP1. The AP1 receives the CTS frame transmitted from the AP2, the AP3, the STA, and another communication device.

After receiving the CTS frame from the STA, the AP1 transmits the TSP to the Tag at timing t123.

The Tag that has received the TSP checks that its own identification information is included in the TSP.

At timing t124, the AP1 starts transmitting the data signal to another communication device.

The Tag receives the data signal (the dashed arrow in the drawing) transmitted from the AP1 to another communication device, and transmits the BCS DATA, which is the backscatter signal to which data information to be transmitted is added, to the AP1 at timing t125. The AP1 receives the BCS DATA.

Meanwhile, another communication device, which has received the data signal transmitted from the AP1, transmits the BA, which is a reception confirmation response signal, to the AP1 at timing t126.

At timing t127, the AP1 transmits the BCS DATA received from the Tag to the STA. The STA can indirectly acquire the BCS DATA by receiving the BCS DATA transmitted from the AP1.

At timing t128, the STA transmits the ACK frame, which is a reception confirmation response signal of the BCS DATA, to the AP1. The AP1 receives the ACK frame. Thereafter, the fourth sequence of FIG. 19 ends.

Note that, in the fourth sequence of FIG. 19, it is necessary for the AP1 to transmit the data signal and receive and acquire the BCS DATA from the Tag at the same time, and thus, it is necessary for the AP1 to support the In-band FD.

### Configuration of ABCS Request Frame>

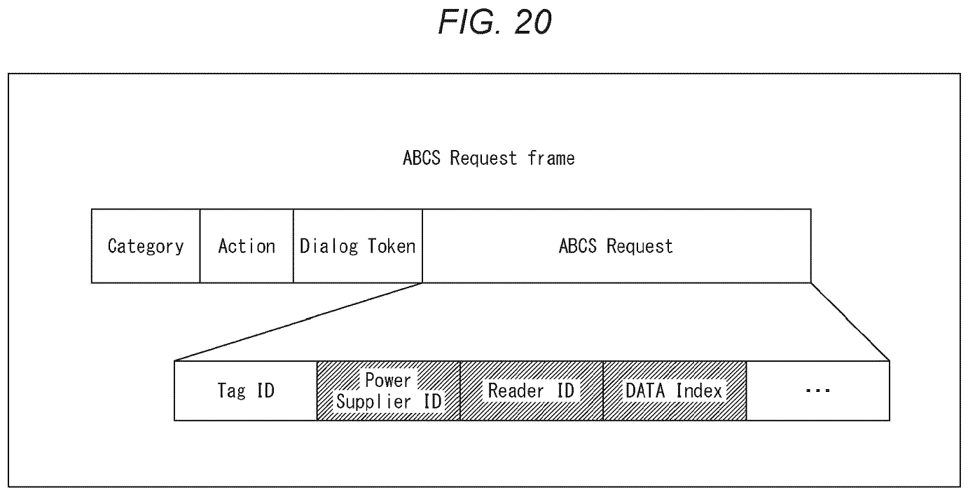

FIG. 20 is a diagram illustrating a configuration example of the ABCS Request frame.

In FIG. 20, the ABCS Request frame is different from the ABCS Operating Mode Notification frame in FIG. 6 in that the ABCS Operating Mode Notification field is replaced with an ABCS Request field.

In FIG. 20, the ABCS Request frame includes fields of Category, Action, Dialog Token, and ABCS Request.

The field of Category includes information indicating that the present Action frame is an ABCS-related frame.

The Action is used in combination with the Category. The field of Action includes information indicating that the present Action frame is the ABCS Request frame.

The field of Dialog Token includes information indicating a processing number of the present Action frame.

The field of ABCS Request includes fields of Tag ID, Power Supplier ID, Reader ID, and DATA Index.

The field of Tag ID includes identification information of a transmission-side Tag of the BCS DATA. The identification information may be a MAC address or identification information that can be managed by the AP.

The field of Power Supplier ID includes identification information of the communication device in charge of the Power Supplier.

The field of Reader ID includes identification information of the communication device in charge of the Reader.

The field of DATA Index includes information indicating the type of the signal transmitted by the Power Supplier. For example, in a case where the DATA Index is 0, None is indicated. In a case where the DATA Index is 1, the data signal to be transmitted to the Reader is indicated. In a case where the DATA Index is 2, the data signal to be transmitted to the AP is indicated. In a case where the DATA Index is 3, the data signal to be transmitted to Other (a terminal other than the Reader) is indicated. In a case where the DATA Index is 4, the CW (a carrier wave having no data) is indicated.

### <Configuration of ABCS Response Frame>

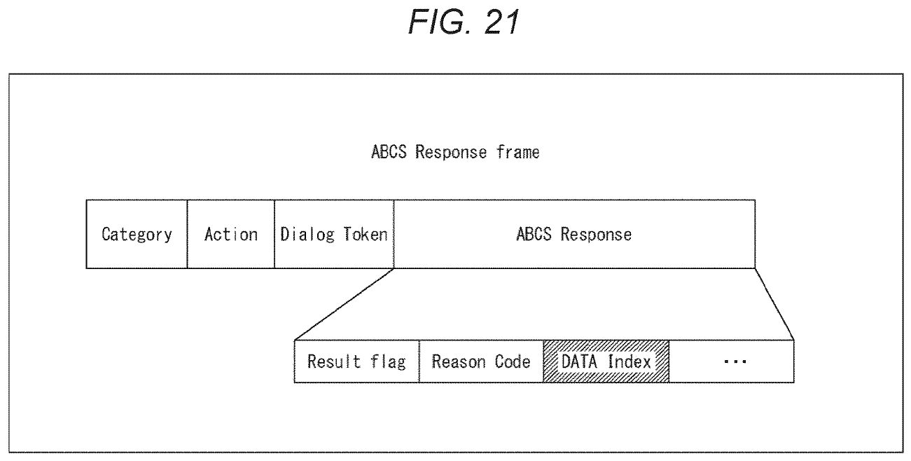

FIG. 21 is a diagram illustrating a configuration example of the ABCS Response frame.

In FIG. 21, the ABCS Response frame is different from the ABCS Operating Mode Notification frame in FIG. 6 in that the ABCS Operating Mode Notification field is replaced with an ABCS Response field.

In FIG. 21, the ABCS Response frame includes fields of Category, Action, Dialog Token, and ABCS Response.

The field of Category includes information indicating that the present Action frame is an ABCS-related frame.

The Action is used in combination with the Category. In the case where the Action is used in combination with the Category, the field of Action includes information indicating that the present Action frame is the ABCS Response frame.

The field of Dialog Token includes information indicating a processing number of the present Action frame.

The field of ABCS Request includes fields of Result flag, Reason Code, and DATA Index.

The field of Result flag includes flag information indicating whether or not the operation in the role (Power Supplier or Reader) requested in the ABCS Request frame is possible.

The field of Reason Code includes information indicating a reason for false in a case where the Result flag is false. Note that the information indicating a reason for false and a list of the reasons are defined in the standard.

The field of DATA Index includes information indicating the type of the signal transmitted by the Power Supplier, similarly to the case of FIG. 20.

<Processing of AP when AP Acquires Transmission Right>

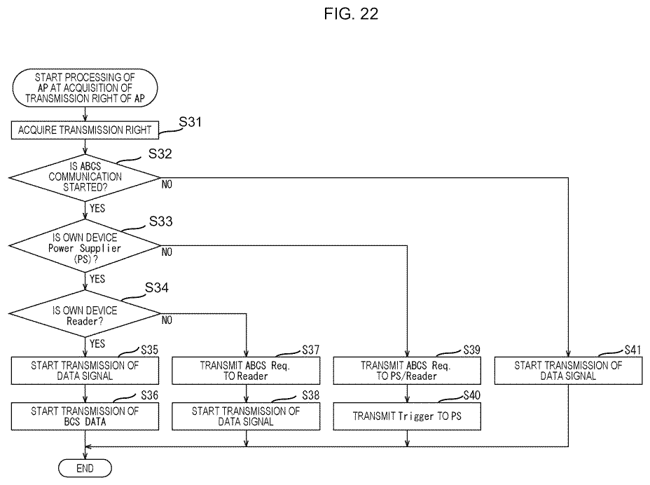

FIG. 22 is a flowchart for describing processing of the AP when the AP acquires the transmission right.

Note that the processing of FIG. 22 is executed by each unit of the wireless communication unit 21 that is controlled by the communication control unit 35 of the communication device 11 of FIG. 2 that operates as the AP.

In step S31, the communication control unit 35 of the AP acquires the transmission right.

In step S32, the communication control unit 35 determines whether or not to start the ABCS communication.

The communication control unit 35 may determine to start the ABCS communication in a case where a certain period of time has elapsed from the timing when the BCS DATA was last received from the Tag on the basis of the ABCS Interval of the ABCS Operating Mode Notification frame received from the STA, for example. Note that, at that time, the AP may receive information indicating timing at which the STA last acquired the BCS DATA by exchanging information in advance.

In step S32, in a case where it is determined to perform the ABCS communication, the processing proceeds to step S33.

In step S33, the communication control unit 35 determines whether or not its own device is in charge of the Power Supplier, that is, whether or not its own device is the Power Supplier. In a case where it is determined in step S33 that its own device is the Power Supplier, the processing proceeds to step S34.

In step S34, the communication control unit 35 determines whether or not its own device is in charge of the Reader, that is, whether or not its own device is the Reader. In a case where it is determined in step S34 that its own device is the Reader, the processing proceeds to step S35.

In step S35, the communication control unit 35 starts transmitting the data signal. Thereafter, the communication control unit 35 receives the BCS DATA transmitted from the Tag.

In step S36, the communication control unit 35 starts transmitting the received BCS DATA to the STA. Thereafter, the processing in FIG. 22 ends.

Furthermore, in step S34, in a case where it is determined that its own device is not the Reader, the processing proceeds to step S37.

In step S37, the communication control unit 35 transmits the ABCS Request frame to the communication device in charge of the Reader.

In step S38, the communication control unit 35 starts transmitting the data signal. Thereafter, the processing in FIG. 22 ends.

Furthermore, in step S33, in a case where it is determined that its own device is not the Power Supplier, the processing proceeds to step S39.

In step S39, the communication control unit 35 transmits the ABCS Request frame to the communication device in charge of the Power Supplier and the communication device in charge of the Reader.

In step S40, the communication control unit 35 transmits the Trigger frame to the communication device in charge of the Power Supplier. Thereafter, the processing in FIG. 22 ends.

Furthermore, in step S32, in a case where it is determined that the ABCS communication is not started, the processing proceeds to step S41.

In step S41, the communication control unit 35 starts transmitting the data signal, as in the related art. Thereafter, the processing in FIG. 22 ends.

### <2. Modifications>

### <Another Configuration of Communication Device>

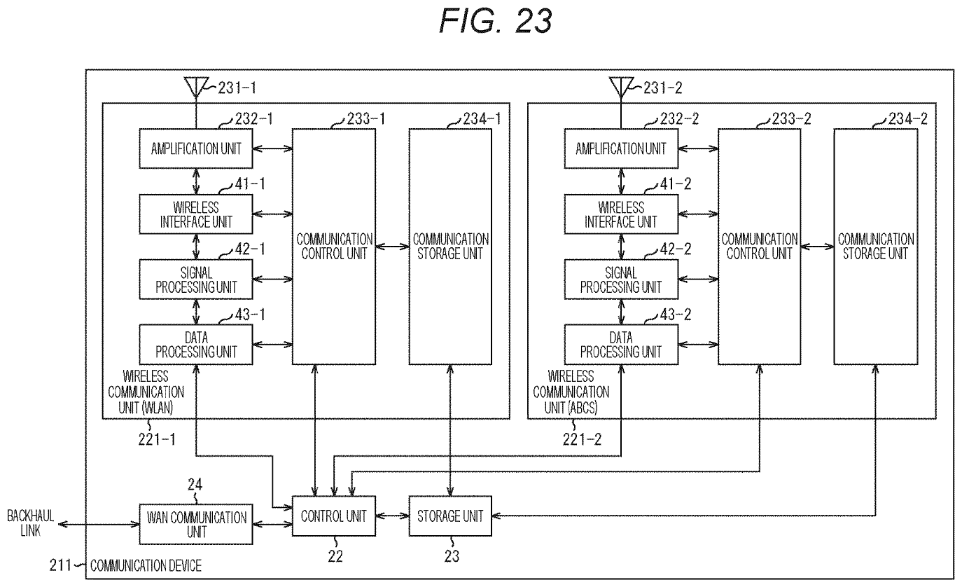

FIG. 23 is a block diagram illustrating another configuration example of a communication device that operates as an AP.

The communication device 211 of FIG. 23 is different from the communication device 11 of FIG. 2 in that the wireless communication unit 21 is replaced with a WLAN wireless communication unit 221-1 and an ABCS wireless communication unit 221-2.

The communication device 211 includes the wireless communication unit 221-1 for WLAN, the wireless communication unit 221-2 for ABCS, a control unit 22, a storage unit 23, and a WAN communication unit 24.

The wireless communication unit 221-1 for WLAN includes an antenna 231-1, an amplification unit 232-1, a wireless interface unit 41-1, a signal processing unit 42-1, a data processing unit 43-1, a communication control unit 233-1, and a communication storage unit 234-1.

The wireless communication unit 221-2 for ABCS includes an antenna 231-2, an amplification unit 232-2, a wireless interface unit 41-1, a signal processing unit 42-1, a data processing unit 43-1, a communication control unit 233-2, and a communication storage unit 234-2.

The antennas 231-1 and 231-2 are configured similarly to the antenna 31 in FIG. 2.

The amplification units 232-1 and 232-2 are configured similarly to the amplification unit 32 in FIG. 2.

The communication control units 233-1 and 233-2 are configured similarly to the communication control unit 35 in FIG. 2.

The communication storage units 234-1 and 234-2 are configured similarly to the communication storage unit 36 in FIG. 2.

In the present technology, a communication device operating as an AP can have the configuration illustrated in FIG. 23. However, the communication device 211 having the configuration of FIG. 23 does not have an interference canceller function, and thus cannot perform functions such as In-band FD and NOMA.

### <Another Configuration of Communication Device>

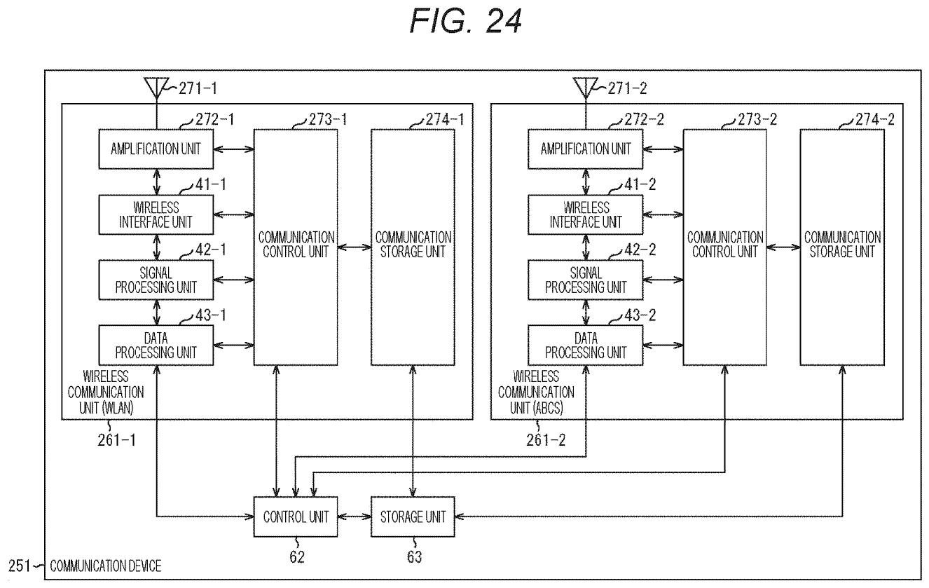

FIG. 24 is a block diagram illustrating another configuration example of the communication device that operates as an STA.

The communication device 251 of FIG. 24 is different from the communication device 51 of FIG. 3 in that the wireless communication unit 61 is replaced with a WLAN wireless communication unit 261-1 and an ABCS wireless communication unit 261-2.

The communication device 251 includes the wireless communication unit 261-1 for WLAN, the wireless communication unit 261-2 for ABCS, a control unit 22, a storage unit 23, and a WAN communication unit 24.

The wireless communication unit 261-1 for WLAN includes an antenna 271-1, an amplification unit 272-1, a wireless interface unit 41-1, a signal processing unit 42-1, a data processing unit 43-1, a communication control unit 273-1, and a communication storage unit 274-1.

The wireless communication unit 261-2 for ABCS includes an antenna 271-2, an amplification unit 272-2, a wireless interface unit 41-1, a signal processing unit 42-1, a data processing unit 43-1, a communication control unit 273-2, and a communication storage unit 274-2.

The antennas 271-1 and 271-2 are configured similarly to the antenna 31 in FIG. 2.

The amplification units 272-1 and 272-2 are configured similarly to the amplification unit 32 in FIG. 2.

The communication control units 273-1 and 273-2 are configured similarly to the communication control unit 35 in FIG. 2.

The communication storage units 274-1 and 274-2 are configured similarly to the communication storage unit 36 in FIG. 2.

In the present technology, a communication device operating as an STA can have the configuration illustrated in FIG. 24. However, the communication device 251 having the configuration of FIG. 24 does not have an interference canceller function, and thus cannot perform functions such as In-band FD and NOMA.

### <3. Application>

### <First Application>

FIG. 1 of the above-described embodiment illustrates the wireless communication system in which only one Tag exists, but hereinafter, a wireless communication system in which a plurality of Tags exists in the same network will be described.

In the wireless communication system in which a plurality of Tags exists in the same network, in a case where the plurality of Tags does not mutually interfere with the other Readers even if the Tags transmit the BCS DATA at the same time, an arbitrary AP may become the Power Supplier and perform operation to cause the plurality of Tags to transmit the BCS DATA at the same time.

Specifically, by performing the following extension for the above-described embodiment, it becomes possible for the AP to be in charge of the Power Supplier and cause the plurality of Tags to transmit the BCS DATA at the same time.

The AP notifies the number of Tags enabled in the same network using a notification signal such as a Beacon. Being enabled means that the AP is notified by each STA in the ABCS Operating Mode Notification frame.

The TSP is transmitted a plurality of times or is extended to be able to specify a plurality of Tags.

In Training Phase, the reception quality measurement for the simultaneous transmission from the plurality of Tags is performed.

A plurality of Tag IDs in various frames and information groups added thereto are extended so as to be included in the same frame.

In a case where an AP with which all of the plurality of Tags can communicate is found on the basis of the reception quality as the measurement result, the Power Supplier is set to the AP.

### <Second Application>

The user may set the transmission of the ABCS Operating Notification frame in the above-described present embodiment.

The setting by the user may be input on a UI on the STA side. Furthermore, the presence or absence of communication from the Tag and the applied role may be displayed on the UI on the STA side.

### <4. Others>

### <Effects of Present Technology>

In the present technology, the communication device that plays the first role of transmitting the third wireless signal necessary for the backscatter signal generation device to generate the BCS DATA (third backscatter signal) is determined by the AP1 (communication control device) on the basis of the first reception quality information related to the reception quality of the BCS DATA for measurement (first backscatter signal) generated by the Tag (backscatter signal generation device) on the basis of the first wireless signal and the second reception quality information related to the reception quality of the BCS DATA for measurement (second backscatter signal) generated by the backscatter signal generation device on the basis of the second wireless signal.

Therefore, according to the present technology, it is possible to optimally perform communication of the backscatter signal. Furthermore, according to the present technology, the following effects can be obtained as compared with the conventional method in which the Power Supplier and the Reader are operated as the same AP.

By sharing the roles of the Power Supplier and the Reader by the plurality of APs, it is not necessary to take an advanced hardware configuration such as the In-band FD, and it is possible to implement the ABCS even with an existing device configuration.

Since the reception quality measurement can be performed to select an AP having no influence of interference on the STA, and the Power Supplier can be determined, the BCS DATA from the Tag can be directly transmitted to the STA, and a delay due to communication can be reduced.

Since a plurality of the APs in charge of the Power Suppliers can be set, the BCS DATA can be received more frequently, and the delay from the necessary timing to the reception of the BCS DATA can be reduced.

Note that, in the above description, the example in which the backscatter signal is generated by the sensor tag has been described, but the device is not limited to the sensor tag as long as the device can generate the backscatter signal.

### <Configuration Example of Computer>

The series of processing steps described above can be executed by hardware and also can be executed by software. In a case where the series of processing steps is executed by software, a program included in the software is installed from a program recording medium on a computer incorporated in dedicated hardware, a general-purpose personal computer, or the like.

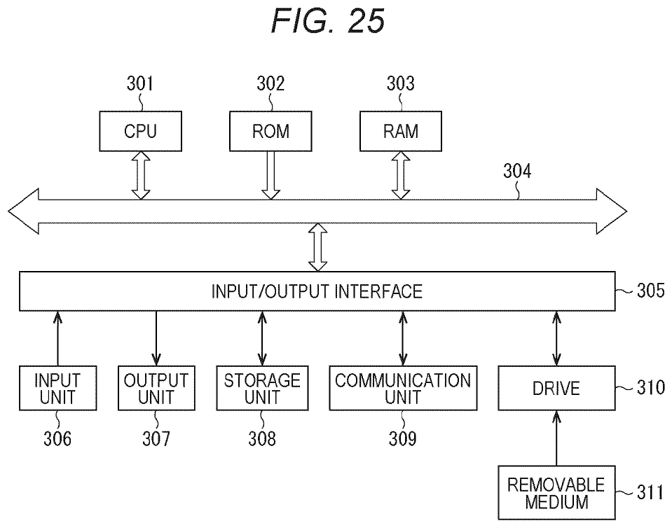

FIG. 25 is a block diagram illustrating a configuration example of hardware of a computer that executes the above-described series of processing by a program.

A central processing unit (CPU) 301, a read only memory (ROM) 302, and a random access memory (RAM) 303 are connected to each other by a bus 304.

Moreover, to the bus 304, an input/output interface 305 is connected. To the input/output interface 305, an input unit 306 including a keyboard, a mouse, and the like, and an output unit 307 including a display, a speaker, and the like are connected. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, for example, the CPU 301 loads a program stored in the storage unit 308 into the RAM 303 via the input/output interface 305 and the bus 304 and executes the program to perform the above-described series of processing.

The program to be executed by the CPU 301 is provided, for example, by being recorded on the removable medium 311 or via a wired or wireless transmission medium such as a local area network, the Internet, or digital broadcasting, and is installed on the storage unit 308.

Note that the program executed by the computer may be a program in which processing is performed in time series in the order described in the present specification or may be a program in which processing is performed in parallel or at necessary timing such as when a call is made.

### <Application Examples>

The present technology can be applied to various products. For example, the communication device 11 in FIG. 2 and the communication device 51 in FIG. 3 may be implemented as a mobile terminal such as a smartphone, a tablet personal computer (PC), a notebook PC, a portable game terminal, or a digital camera, a fixed terminal such as a television receiver, a printer, a digital scanner, or a network storage, or an in-vehicle terminal such as a car navigation device. Furthermore, the communication device 11 and the communication device 51 may be implemented as a machine to machine communication (M2M) terminal such as a smart meter, a vending machine, a remote monitoring device, or a point of sale (POS) terminal. Moreover, the communication device 11 and the communication device 51 may each be a wireless communication module (for example, an integrated circuit module including one die) mounted on these terminals.

On the other hand, for example, the communication device 11 and the communication device 51 may be implemented as a wireless LAN AP (wireless base station) having a router function or not having a router function. Furthermore, the communication device 11 and the communication device 51 may be implemented as mobile wireless LAN routers. Moreover, the communication device 11 and the communication device 51 may be wireless communication modules (for example, an integrated circuit module including one die) mounted on these devices.

### <Configuration Example of Smartphone>

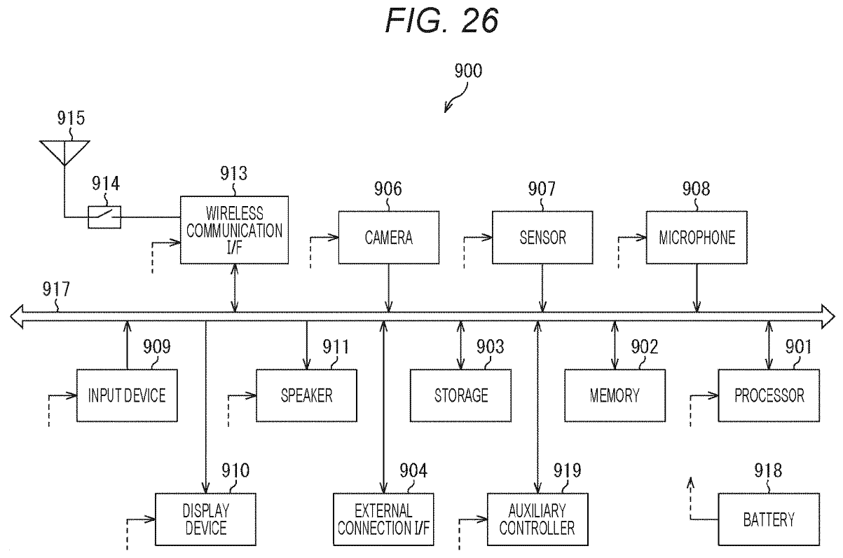

FIG. 26 is a block diagram illustrating a schematic configuration example of the smartphone to which the present technology is applied.

A smartphone 900 includes a processor 901, a memory 902, a storage 903, an external connection interface 904, a camera 906, a sensor 907, a microphone 908, an input device 909, and a display device 910. Furthermore, the smartphone 900 includes a speaker 911, a wireless communication interface 913, an antenna switch 914, an antenna 915, a bus 917, a battery 918, and an auxiliary controller 919.

The processor 901 may be, for example, a CPU or a system on chip (SoC), and restricts functions of an application layer and other layers of the smartphone 900.

The memory 902 includes a RAM and a ROM, and stores a program to be executed by the processor 901, and data.

The storage 903 may include a storage medium such as a semiconductor memory or a hard disk.

The external connection interface 904 is an interface for connecting an external device such as a memory card or a universal serial bus (USB) device to the smartphone 900.

The camera 906 includes an imaging element such as a charge coupled device (CCD) or a complementary metal oxide semiconductor (CMOS), for example, and generates a captured image.

The sensor 907 includes, for example, a sensor group including a positioning sensor, a gyro sensor, a geomagnetic sensor, and an acceleration sensor.

The microphone 908 converts audio input to the smartphone 900 into an audio signal.

The input device 909 includes, for example, a touch sensor that detects a touch on a screen of the display device 910, a keypad, a keyboard, a button, and a switch, and receives an operation by the user or information input from the user.

The display device 910 has a screen such as a liquid crystal display (LCD) or an organic light emitting diode (OLED) display, and converts the audio signal output from the smartphone 900 into audio.

The wireless communication interface 913 supports one or more of wireless LAN standards such as IEEE 802.11a, 11b, 11g, 11ac, and 11ad, and performs wireless communication.

The wireless communication interface 913 communicates with other devices via the wireless LAN AP in an infrastructure mode. Furthermore, the wireless communication interface 913 directly communicates with other devices in an ad hoc mode or a direct communication mode such as Wi-Fi Direct.

Note that, in Wi-Fi Direct, unlike the ad hoc mode, one of two terminals operates as an AP, but communication is directly performed between the terminals.

The wireless communication interface 913 typically includes a baseband processor, a radio frequency (RF) circuit, and a power amplifier. The wireless communication interface 913 may be a one-chip module in which a memory that stores a communication control program, a processor that executes the program, and related circuits are integrated.

In addition to the wireless LAN scheme, the wireless communication interface 913 may support other types of wireless communication schemes such as a short-range wireless communication scheme, a proximity wireless communication scheme, and a cellular communication scheme.

The antenna switch 914 switches a connection destination of the antenna 915 among a plurality of circuits (for example, circuits for different wireless communication schemes) included in the wireless communication interface 913.

The antenna 915 has a single or a plurality of antenna elements (for example, a plurality of the antenna elements forming a multiple input multiple output (MIMO) antenna), and is used for transmission and reception of a wireless signal by the wireless communication interface 913.

Note that the smartphone 900 is not limited to the example in FIG. 26, and may include a plurality of the antennas (for example, an antenna for the wireless LAN, an antenna of the proximity wireless communication scheme, and the like). In that case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to one another.

The battery 918 supplies power to each block of the smartphone 900 illustrated in FIG. 26 through a feed line partially indicated by the dashed line in the drawing. The auxiliary controller 919 causes operation of minimum necessary functions of the smartphone 900, for example, in a sleep mode.

In the smartphone 900 illustrated in FIG. 26, for example, the communication control unit 35 in FIG. 2 or the communication control unit 75 in FIG. 3 may be implemented in the wireless communication interface 913. Furthermore, at least some of these functions may be implemented in the processor 901 or the auxiliary controller 919.

Note that the smartphone 900 may operate as a wireless AP (software AP) when the processor 901 executes an AP function at an application level. Furthermore, the wireless communication interface 913 may have the wireless AP function.

Moreover, the smartphone 900 may include a biometric authentication unit (fingerprint authentication, palm-shape authentication, voice authentication, blood vessel authentication, face authentication, iris authentication, and retina authentication). At that time, the wireless communication interface 913 in which the communication control unit 35 in FIG. 2 or the communication control unit 75 in FIG. 3 is implemented is configured to receive power supply from the same battery 918 as at least one of the display device 910, the speaker 911, or the biometric authentication unit.

Furthermore, in the smartphone 900, information is displayed from at least one of the display device 910 or the speaker 911 on the basis of communication with an external device through the wireless communication interface 913. At that time, the information regarding the present technology may be output from at least one of the display device 910 or the speaker 911.

### <Configuration Example of In-vehicle Device>

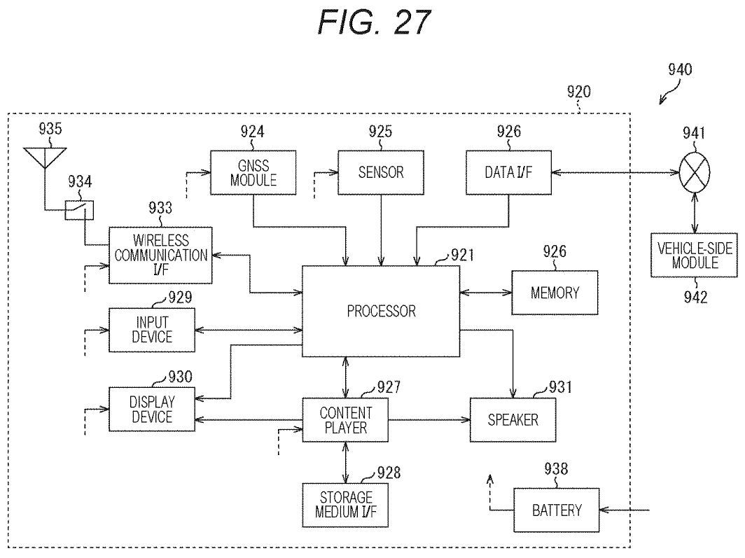

FIG. 27 is a block diagram illustrating a schematic configuration example of an in-vehicle device 920 to which the present technology is applied.

The in-vehicle device 920 includes a processor 921, a memory 922, a global navigation satellite system (GNSS) module 924, a sensor 925, a data interface 926, a content player 927, and a storage medium interface 928. Furthermore, the in-vehicle device 920 includes an input device 929, a display device 930, a speaker 931, a wireless communication interface 933, an antenna switch 934, an antenna 935, and a battery 938.

The processor 921 may be, for example, a CPU or an SoC, and controls a navigation function and other functions of the in-vehicle device 920. Furthermore, the processor 921 can also control a drive system of a vehicle, such as a brake, an accelerator, or a steering, on the basis of information obtained through communication based on the present technology.

The memory 922 includes a RAM and a ROM, and stores a program to be executed by the processor 921, and data.

The GNSS module 924 uses a GNSS signal received from a GNSS satellite to measure a location (for example, latitude, longitude, and altitude) of the in-vehicle device 920.

The sensor 925 includes, for example, a sensor group including a gyro sensor, a geomagnetic sensor, and an air pressure sensor.

The data interface 926 is connected to an in-vehicle network 941 via, for example, a terminal (not illustrated), and acquires data generated on the vehicle side, such as in-vehicle data.

The content player 927 reproduces contents stored in a storage medium (for example, a CD or a DVD) inserted into the storage medium interface 928.

The input device 929 includes, for example, a touch sensor that detects a touch on a screen of the display device 930, a button, a switch, or the like, and receives an operation by the user or information input from the user.

The display device 930 has a screen such as an LCD or an OLED display, and displays an image of a navigation function or contents to be reproduced.

The speaker 931 outputs sound of the navigation function or contents to be reproduced.

Note that, in the in-vehicle device 920, the navigation function and the function of the content player 927 are optional. The navigation function and the content player 927 may be removed from the configuration of the in-vehicle device 920.

The wireless communication interface 933 supports one or more of wireless LAN standards such as IEEE 802.11a, 11b, 11g, 11n, 11ac, 11ad, 11ax, and 11be, and performs wireless communication. The wireless communication interface 933 communicates with other devices via the wireless LAN AP in the infrastructure mode. Furthermore, the wireless communication interface 933 directly communicates with other devices in an ad hoc mode or a direct communication mode such as Wi-Fi Direct.

The wireless communication interface 933 typically includes a baseband processor, an RF circuit, and a power amplifier. The wireless communication interface 933 may be a one-chip module in which a memory that stores a communication control program, a processor that executes the program, or related circuits are integrated. In addition to the wireless LAN scheme, the wireless communication interface 933 may support other types of wireless communication schemes such as a short-range wireless communication scheme, a proximity wireless communication scheme, and a cellular communication scheme.

The antenna switch 934 switches a connection destination of the antenna 935 among a plurality of circuits included in the wireless communication interface 933.

The antenna 935 has a single or a plurality of antenna elements, and is used for transmission and reception of a wireless signal through the wireless communication interface 933.

Note that the in-vehicle device 920 is not limited to the example in FIG. 27, and may include a plurality of the antennas 935. In that case, the antenna switch 934 may be omitted from the configuration of the in-vehicle device 920.

In the in-vehicle device 920 illustrated in FIG. 27, the battery 938 may supply power through a feed line partially illustrated by the dashed line in the drawing, and for example, the communication control unit 35 in FIG. 2 or the communication control unit 75 in FIG. 3 may be mounted in the wireless communication interface 933. Furthermore, at least some of these functions may be implemented in the processor 921.

Furthermore, the wireless communication interface 933 may operate as the above-described communication device 11 or communication device 51, and provide wireless connection to a terminal possessed by a user in the vehicle.

Furthermore, the present technology may be implemented as an in-vehicle system (or vehicle) 940 including one or more blocks of the in-vehicle device 920 described above, the in-vehicle network 941, and a vehicle-side module 942. The vehicle-side module 942 generates vehicle-side data such as a vehicle speed, an engine speed, or failure information, and outputs the generated data to the in-vehicle network 941.

### <Configuration Example of Wireless AP>

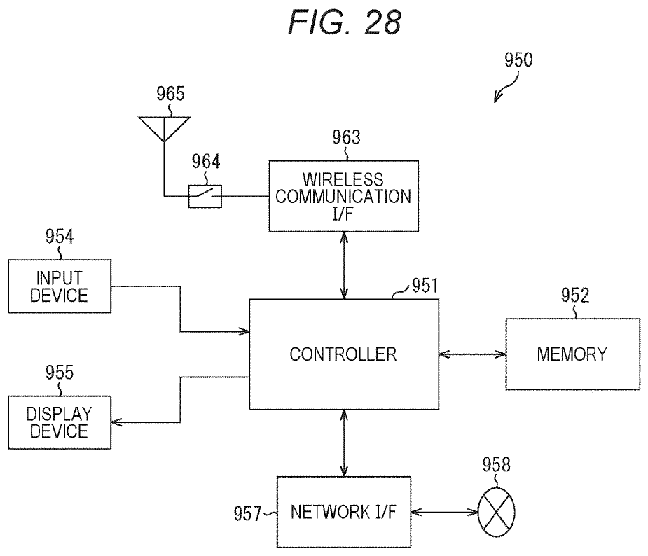

FIG. 28 is a block diagram illustrating a schematic configuration example of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

The controller 951 may be, for example, a CPU or a digital signal processor (DSP), and operates various functions (for example, access restriction, routing, encryption, firewall, log management, and the like) of the Internet protocol (IP) layer and higher layer of the wireless AP 950.

The memory 952 includes a RAM and a ROM, and stores a program to be executed by the controller 951 and various control information (for example, a terminal list, a routing table, an encryption key, a security setting, a log, and the like).

The input device 954 includes, for example, a button and a switch, and receives an operation from the user.

The display device 955 includes an LED lamp and the like, and displays an operation status of the wireless AP 950.

The network interface 957 is a wired communication interface for connecting the wireless AP 950 to a wired communication network 958. The network interface 957 may have a plurality of connection terminals. The wired communication network 958 may be a LAN such as Ethernet (registered trademark), or may be a wide area network (WAN).

The wireless communication interface 963 supports one or more of the wireless LAN standards such as IEEE 802.11a, 11b, 11g, 11n, 11ac, and 11ad, and provides wireless connection as an AP to a nearby terminal.

The wireless communication interface 963 typically includes a baseband processor, an RF circuit, and a power amplifier.

The wireless communication interface 963 may be a one-chip module in which a memory that stores a communication control program, a processor that executes the program, or related circuits are integrated.

The antenna switch 964 switches a connection destination of the antenna 965 among a plurality of circuits included in the wireless communication interface 963, and the antenna 965 has a single or a plurality of antenna elements and is used for transmission and reception of a wireless signal through the wireless communication interface 963.

In the wireless AP 950 illustrated in FIG. 28, for example, the communication control unit 35 in FIG. 2 or the communication control unit 75 in FIG. 3 may be implemented in the wireless communication interface 963. Furthermore, at least some of these functions may be implemented in the controller 951.

Note that, the above-described embodiments describe an example for embodying the present technology, and there is a correspondence relationship between the matters in the embodiments and the matters specifying the invention in claims. Similarly, there is a correspondence relationship between the matters specifying the invention in claims and the matters in the embodiments of the present technology having the same names. However, the present technology is not limited to the embodiments, and can be embodied by applying various modifications to the embodiments without departing from the scope of the present technology.

Furthermore, the procedures described in the above-described embodiment may be considered as a method including a series of procedures and may be considered as a program for causing this computer to execute the series of procedures and a recording medium that stores the program.

As this recording medium, for example, a compact disc (CD), a MiniDisc (MD), a digital versatile disc (DVD), a memory card, a Blu-ray (registered trademark) Disc, and the like can be used.

Note that, in the present specification, a system means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both systems.

Furthermore, the effects described in the present specification are merely examples and not restrictive, and there may also be other effects.

An embodiment of the present technology is not limited to the embodiment described above, and various modifications can be made without departing from the scope of the present technology.

For example, the present technology may be configured as cloud computing in which one function is shared by a plurality of devices via a network and processed in cooperation.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### Combination Example 1 of Configurations

The present technology can also be configured as follows.

(1)

A communication control device including:
a communication control unit configured to determine a communication device that plays a first role of transmitting a third wireless signal necessary for a backscatter signal generation device to generate a third backscatter signal on the basis of first reception quality information relating to reception quality of a first backscatter signal generated by the backscatter signal generation device on the basis of a first wireless signal and second reception quality information relating to reception quality of a second backscatter signal generated by the backscatter signal generation device on the basis of a second wireless signal.
   (2)

The communication control device according to (1) above, in which
the backscatter signal generation device generates the first backscatter signal by reflecting and absorbing the first wireless signal, and generates the second backscatter signal by reflecting and absorbing the second wireless signal.
   (3)

The communication control device according to (1) or (2) above, in which
the first wireless signal is transmitted by a first communication device,
the second wireless signal is transmitted by a second communication device, and
the first reception quality information indicates the reception quality of the first backscatter signal measured in a third communication device, and the second reception quality information indicates the reception quality of the second backscatter signal measured in the third communication device.
   (4)

The communication control device according to (3) above, in which
the communication control unit determines the communication device that plays the first role from between the first communication device and the second communication device on the basis of the first reception quality information and the second reception quality information included in a response signal received from the third communication device.
   (5)

The communication control device according to (4) above, in which
the response signal includes an ID of the backscatter signal generation device and an ID of the communication device of which the reception quality is measured.
   (6)

The communication control device according to (3) above, in which,
in a case where the communication control unit is provided in the first communication device, the communication control unit transmits a coordinated measurement request signal requesting coordinated reception quality measurement to the second communication device, and then transmits the first wireless signal.
   (7)

The communication control device according to (1) or (2) above, in which
the first reception quality information includes a reception signal to interference and noise ratio (SINR) or a bit error rate of the first backscatter signal, and
the second reception quality information includes a reception SINR or a bit error rate of the second backscatter signal.
   (8)

The communication control device according to (1) or (2) above, in which
the communication control unit determines a communication device that plays a second role of receiving the third backscatter signal transmitted by the backscatter signal generation device on the basis of third reception quality information indicating reception quality measured in a fourth communication device for the first backscatter signal generated by the backscatter signal generation device on the basis of the first wireless signal and fourth reception quality information indicating reception quality measured in a fifth communication device for the first backscatter signal.
   (9)

The communication control device according to (8) above, in which
the communication control unit determines the communication device that plays the second role from between the fourth communication device and the fifth communication device on the basis of the third reception quality information included in a first response signal received from the fourth communication device and the fourth reception quality information included in a second response signal received from the fifth communication device.
   (10)

The communication control device according to (9) above, in which
each of the first response signal and the second response signal includes an ID of the backscatter signal generation device and an ID of the communication device of which the reception quality is measured.
   (11)

The communication control device according to (8) above, in which
the communication control unit performs processing of determining the communication device that plays the second role from between the fourth communication device and the fifth communication device on the basis of the third reception quality information and the fourth reception quality information in a case where the communication device that plays the first role is not determined.
   (12)

The communication control device according to (8) above, in which
the third reception quality information and the fourth reception quality information include a reception SINR or a bit error rate of the first backscatter signal.
   (13)

The communication control device according to (8) above, in which
the communication control unit transmits a setting signal including first identification information indicating the determined communication device that plays the first role and second identification information indicating the determined communication device that plays the second role to the communication device that plays the first role and the communication device that plays the second role.
   (14)

The communication control device according to (8) above, in which
the communication control unit receives the third backscatter signal in a case where the communication control unit is provided in the communication device that plays the second role.
   (15)

The Communication Control Device According to (8) Above, in which
the communication control unit receives the third wireless signal in a case where the communication control unit is provided in the communication device that plays the first role.
   (16)

A communication control method in which
a communication control device determines a communication device that plays a first role of transmitting a third wireless signal necessary for a backscatter signal generation device to generate a third backscatter signal on the basis of first reception quality information relating to reception quality of a first backscatter signal generated by the backscatter signal generation device on the basis of a first wireless signal and second reception quality information relating to reception quality of a second backscatter signal generated by the backscatter signal generation device on the basis of a second wireless signal.
   (17)

A program for causing a computer to function as:
a communication control unit configured to determine a communication device that plays a first role of transmitting a third wireless signal necessary for a backscatter signal generation device to generate a third backscatter signal on the basis of first reception quality information relating to reception quality of a first backscatter signal generated by the backscatter signal generation device on the basis of a first wireless signal and second reception quality information relating to reception quality of a second backscatter signal generated by the backscatter signal generation device on the basis of a second wireless signal.

### Combination Example 2 of Configurations

Furthermore, the present technology may also adopt the following configurations.

(1)

A communication control device including:
a communication control unit configured to measure first reception quality for a first backscatter signal each generated by a backscatter signal generation device on the basis of a first wireless signal, and measure second reception quality for a second backscatter signal each generated by the backscatter signal generation device on the basis of a second wireless signal.
   (2)

The communication control device according to (1) above, in which
the backscatter signal generation device generates the first backscatter signal by reflecting and absorbing the first wireless signal, and generates the second backscatter signal by reflecting and absorbing the second wireless signal.
   (3)

The communication control device according to (1) or (2) above, in which
first reception quality information indicating the first reception quality and second reception quality information indicating the second reception quality are transmitted to a first communication device, and
a communication device that plays a first role of transmitting a third wireless signal for the backscatter signal generation device to generate a third backscatter signal is determined by the first communication device on the basis of the first reception quality information and the second reception quality information.
   (4)

The communication control device according to (3) above, in which
a communication device that plays a second role of receiving the third backscatter signal transmitted by the backscatter signal generation device is determined by the first communication device on the basis of the first reception quality information and the second reception quality information.
   (5)

The communication control device according to (4) above, in which
the communication control unit performs control to include the first reception quality information and the second reception quality information in one response signal and transmit the response signal to the first communication device.
   (6)

The communication control device according to (5) above, in which
the first reception quality information includes a reception signal to interference and noise ratio (SINR) or a bit error rate of the first backscatter signal, and
the second reception quality information includes the reception SINR or the bit error rate of the second backscatter signal.
   (7)

The communication control device according to (5) above, in which
the response signal includes an ID of the backscatter signal generation device and an ID of a communication device of which the first reception quality and the second reception quality are measured.
   (8)

The communication control device according to (4) above, in which
the communication control unit receives a setting signal including first identification information indicating the determined communication device that plays the first role and second identification information indicating the determined communication device that plays the second role in a case where the communication control unit is provided in the communication device that plays the first role or the second role, and determines an operation on the basis of the setting signal.
   (9)

The communication control device according to (8) above, in which
the communication control unit receives the third backscatter signal on the basis of a transmission request signal related to transmission of the third backscatter signal transmitted from the communication device that plays the first role in a case where the communication control unit is provided in the communication device that plays the second role.
   (10)

The communication control device according to (3) above, in which
the communication control unit measures the first reception quality for the first backscatter signal and measures the second reception quality for the second backscatter signal on the basis of a measurement request signal requesting measurement of the first reception quality and the second reception quality.
   (11)

The communication control device according to (10) above, in which the communication control unit measures the first reception quality and the second reception quality on the basis of information regarding the number of communication devices that play the first role and a data length included in the measurement request signal.

(12)

A communication control method in which
a communication control device includes:
a communication control unit configured to measure first reception quality for a first backscatter signal each generated by a backscatter signal generation device on the basis of a first wireless signal, and measure second reception quality for a second backscatter signal each generated by the backscatter signal generation device on the basis of a second wireless signal.
   (13)

A program for causing a computer to function as:
a communication control unit that measures first reception quality for a first backscatter signal each generated by a backscatter signal generation device on the basis of a first wireless signal, and measures second reception quality for a second backscatter signal each generated by the backscatter signal generation device on the basis of a second wireless signal.

### REFERENCE SIGNS LIST

11 Communication device

21 Wireless communication unit

22 Control unit

23 Storage unit

24 WAN communication unit

31 Antenna

32 Amplification unit

33 WLAN unit

34 ABCS unit

35 Communication control unit

36 Communication storage unit

41, 41-1, 41-2 Wireless interface unit

42, 42-1, 42-2 Signal processing unit

43, 43-1, 43-2 Data processing unit

51 Communication device

61 Wireless communication unit

62 Control unit

63 Storage unit

71 Antenna

72 Amplification unit

73 WLAN unit

74 ABCS unit

75 Communication control unit

76 Communication storage unit

111 Communication device

121 Wireless communication unit

122 Control unit

123 Storage unit

131 Antenna

132 Switching unit

133 Signal reflection/absorption control unit

134 Transmission signal processing unit

135 Reception signal detection unit

136 Reception signal processing unit

137 Communication control unit

What is claimed is:

1. A communication control device comprising:
a communication control unit configured to determine a communication device that plays a first role of transmitting a third wireless signal necessary for a backscatter signal generation device to generate a third backscatter signal on a basis of first reception quality information relating to reception quality of a first backscatter signal generated by the backscatter signal generation device on a basis of a first wireless signal and second reception quality information relating to reception quality of a second backscatter signal generated by the backscatter signal generation device on a basis of a second wireless signal.

2. The communication control device according to claim 1, wherein
the backscatter signal generation device generates the first backscatter signal by reflecting and absorbing the first wireless signal, and generates the second backscatter signal by reflecting and absorbing the second wireless signal.

3. The communication control device according to claim 1, wherein
the first wireless signal is transmitted by a first communication device,
the second wireless signal is transmitted by a second communication device, and
the first reception quality information indicates the reception quality of the first backscatter signal measured in a third communication device, and the second reception quality information indicates the reception quality of the second backscatter signal measured in the third communication device.

4. The communication control device according to claim 3, wherein
the communication control unit determines the communication device that plays the first role from between the first communication device and the second communication device on a basis of the first reception quality information and the second reception quality information included in a response signal received from the third communication device.

5. The communication control device according to claim 4, wherein
the response signal includes an ID of the backscatter signal generation device and an ID of the communication device of which the reception quality is measured.

6. The communication control device according to claim 3, wherein,
in a case where the communication control unit is provided in the first communication device, the communication control unit transmits a coordinated measurement request signal requesting coordinated reception quality measurement to the second communication device, and then transmits the first wireless signal.

7. The communication control device according to claim 1, wherein
the first reception quality information includes a reception signal to interference and noise ratio (SINR) or a bit error rate of the first backscatter signal, and
the second reception quality information includes a reception SINR or a bit error rate of the second backscatter signal.

8. The communication control device according to claim 1, wherein
the communication control unit determines a communication device that plays a second role of receiving the third backscatter signal transmitted by the backscatter signal generation device on a basis of third reception quality information indicating reception quality measured in a fourth communication device for the first backscatter signal generated by the backscatter signal generation device on a basis of the first wireless signal and fourth reception quality information indicating reception quality measured in a fifth communication device for the first backscatter signal.

9. The communication control device according to claim 8, wherein
the communication control unit determines the communication device that plays the second role from between the fourth communication device and the fifth communication device on a basis of the third reception quality information included in a first response signal received from the fourth communication device and the fourth reception quality information included in a second response signal received from the fifth communication device.

10. The communication control device according to claim 9, wherein
each of the first response signal and the second response signal includes an ID of the backscatter signal generation device and an ID of the communication device of which the reception quality is measured.

11. The communication control device according to claim 8, wherein
the communication control unit performs processing of determining the communication device that plays the second role from between the fourth communication device and the fifth communication device on a basis of the third reception quality information and the fourth reception quality information in a case where the communication device that plays the first role is not determined.

12. The communication control device according to claim 8, wherein
the third reception quality information and the fourth reception quality information include a reception SINR or a bit error rate of the first backscatter signal.

13. The communication control device according to claim 8, wherein
the communication control unit transmits a setting signal including first identification information indicating the determined communication device that plays the first role and second identification information indicating the determined communication device that plays the second role to the communication device that plays the first role and the communication device that plays the second role.

14. The communication control device according to claim 8, wherein
the communication control unit receives the third backscatter signal in a case where the communication control unit is provided in the communication device that plays the second role.

15. The communication control device according to claim 8, wherein
the communication control unit receives the third wireless signal in a case where the communication control unit is provided in the communication device that plays the first role.

16. A communication control method in which
a communication control device determines a communication device that plays a first role of transmitting a third wireless signal necessary for a backscatter signal generation device to generate a third backscatter signal on a basis of first reception quality information relating to reception quality of a first backscatter signal generated by the backscatter signal generation device on a basis of a first wireless signal and second reception quality information relating to reception quality of a second backscatter signal generated by the backscatter signal generation device on a basis of a second wireless signal.

17. A program for causing a computer to function as:
a communication control unit configured to determine a communication device that plays a first role of transmitting a third wireless signal necessary for a backscatter signal generation device to generate a third backscatter signal on a basis of first reception quality information relating to reception quality of a first backscatter signal generated by the backscatter signal generation device on a basis of a first wireless signal and second reception quality information relating to reception quality of a second backscatter signal generated by the backscatter signal generation device on a basis of a second wireless signal.
